(19) United States
(12) Patent Application Publication
(10) Pub. No.: US 2023/0298010 A1
(43) Pub. Date: Sep. 21, 2023

(54) PLATFORM OPERATOR DEVICE SUPPORTING ISSUANCE OF MULTI-ASSET-BACKED SECURITY TOKENS

(71) Applicant: ENTERPRISE BLOCKCHAIN CO., LTD., Seoul (KR)

(72) Inventors: Junsup Lee, Seoul (KR); Taeho Gwak, Seoul (KR); Kwanlae Kim, Yongin-si (KR); Jonghyeok Jeon, Gwangju-si (KR); Changho Moon, Yongin-si (KR); Woonhyuk Baek, Seoul (KR); Jaeho Yoon, Seoul (KR)

(73) Assignee: ENTERPRISE BLOCKCHAIN CO., LTD., Seoul (KR)

(21) Appl. No.: 18/142,900

(22) Filed: May 3, 2023

Related U.S. Application Data
(63) Continuation of application No. PCT/KR2021/016180, filed on Nov. 9, 2021.

(30) Foreign Application Priority Data
Nov. 12, 2020 (KR) 10-2020-0151019

(51) Int. Cl. G06Q 20/36; G06Q 20/38; G06Q 20/40

(52) U.S. Cl. CPC G06Q 20/3678; G06Q 20/389; G06Q 20/401

(57) ABSTRACT

Provided is a platform operator device supporting an issuance of multi-assets-backed security tokens on a blockchain network. The platform operator device comprises memory, a processor, a display unit, and a communication unit. The processor of the platform operator device is configured to communicate, by means of the communication unit and a communication network, with: one or more token issuer terminals; one or more investor terminals; and one or more custody institute servers managing the one or more token issuer terminals, respectively, the one or more investor terminals, respectively, or each electronic money wallet associated with the platform operator device, wherein the block chain network includes a plurality of computing devices performing P2P communication with each other, each of the computing devices includes at least a portion of a blockchain distributed ledger on which a plurality of pieces of smart contract code by which prescribed types of transactions are respectively made on the blockchain network and information about each of the transactions made by executing the respective pieces of smart contract code are recorded, and the plurality of pieces of smart contract code include at least issuance contract code and vault contract code.

### CROSS REFERENCE TO RELATED APPLICATION

This application is a continuation application, claiming priority under §365(c), of an International application No. PCT/KR2021/016180, filed on Nov. 09, 2021, which is based on and claims the benefit of a Korean patent application number 10-2020-0151019, filed on Nov. 12, 2020, in the Korean Intellectual Property Office, the disclosure of which is incorporated by reference herein in its entirety.

### TECHNICAL FIELD

The disclosure relates to development of a new type of financial investment product based on a blockchain, more particularly, a security token that may be issued and operated on a blockchain network. The disclosure particularly relates to a platform operator device that supports an issuance and operation of the security tokens based on a plurality of assets.

### BACKGROUND ART

Ever since Satoshi Nakamoto introduced a blockchain technology with cryptocurrency Bitcoin to the world, interests in various forms of cryptocurrencies and the blockchain technologies that support them has been growing. Blockchain technologies are being discussed for their potential applications in a variety of fields, as they enable transactions based on a decentralized, distributed, and shared ledger, providing greater openness, trust, transparency, and interactivity. In particular, as newer blockchain technologies such as Ethereum, which followed Bitcoin, support smart contracts, i.e., digital contracts each of which has the terms specified on the blockchain and is automatically executed when the terms are met, various forms of blockchain technologies are being used in various industries, especially in the financial sector.

Meanwhile, the vitalization of investment is tied to an issue of liquidity. Liquidity refers to an easiness/degree to which assets may be converted into cash. Traditional high-value assets, such as large real estate properties or famous art works, are inaccessible to the general public due to their lack of liquidity, so that they have been considered as being in the realm of investment only for the wealthy people. In recent years, with the increasing use of blockchain technologies in the financial sector, there have been attempts to digitally tokenize the rights to various types of tangible or intangible assets, such as real estate, artwork, investment funds in privately held companies, and various intellectual property rights, and to offer the tokenized rights for transactions on the blockchain network. In this case, the digital tokens issued on the basis of tangible or intangible assets are security tokens (more precisely, asset backed security tokens) that embody legal ownership rights to obtain revenue (dividends, operating revenue, etc.) from the underlying asset itself or to transfer the ownership of the asset itself, unlike utility tokens (tokens with rights to use specific services provided on the corresponding blockchain network) issued through conventional ICOs. There are expectations that the growth of the security token market will improve asset liquidity and thus vitalize various forms of investment markets to serve as an important bridge between traditional financial markets and the blockchain technology field.

### DISCLOSURE

### Technical Problem

However, the security token market is just beginning to take off, and most of the security tokens issued are in the form of so-called single-asset backed security tokens, which are simply issued on the blockchain network based on a given single asset, such as real estate or artwork. Given the existence of various investment products in the traditional financial market, it is necessary to think about the development of new types of financial products utilizing conventional single-asset backed security tokens in the security token market.

### Technical Solution

According to an aspect of the disclosure, there is provided a platform operator device that supports an issuance of multi-assets backed security tokens on a blockchain network. The platform operator device comprises a memory, a processor, a display unit, and a communication unit. The processor is configured to communicate, via the communication unit and a communication network, with one or more token issuer terminals, one or more investor terminals, and one or more custody institution servers managing a respective digital currency wallet associated with each of the one or more token issuer terminals, each of the one or more investor terminals, or the platform operator device. The blockchain network includes a plurality of computing devices performing peer-to-peer communication with each other, each of the computing devices including at least a portion of a blockchain distributed ledger that records a plurality of smart contract codes that respectively enable a transaction to occur on the blockchain network, and information regarding each transaction established by execution of each of the smart contract codes, the plurality of smart contract codes including, at least, an issuance contract code and a vault contract code. The processor, when receiving a first single-asset backed security token issuance request based on a first single-asset from a first token issuer terminal, enables the issuance contract code to be executed on the blockchain network to support issuance of a plurality of first single-asset backed security tokens. The processor, when receiving a second single-asset backed security token issuance request based on a second single-asset from a second token issuer terminal, enables the issuance contract code to be executed on the blockchain network to support issuance of a plurality of second single-asset backed security tokens. The processor, when receiving a multi-assets backed security token issuance request from a third token issuer terminal, enables the vault contract code to be executed on the blockchain network to bind a first number of the first single-asset backed security tokens and a second number of the second single-asset backed security tokens according to the issuance request, and to support issuance of a plurality of multi-assets backed security tokens using the binding as an underlying asset.

According to an embodiment of the disclosure, the first single-asset backed security token issuance request may include at least one information regarding the first single-asset backed security tokens, among information about the first single-asset, a token name, a total amount of tokens to be issued, a price per token, an operating revenue related to the first single-asset, an expected annual interest related to the first single-asset, a dividend payment period, a time span for which dividends are to be paid, and a token sales closing date. The second single-asset backed security token issuance request may include at least one information related to the second single-asset backed security tokens, among information about the second single-asset, a token name, a total amount of tokens to be issued, a price per token, an operating revenue related to the second single-asset, an expected annual interest related to the second single-asset, a dividend payment period, a time span for which a dividends are to be paid, and a token sales closing date. The multi-assets backed security token issuance request may include at least one information related to the multi-assets backed security tokens, among respective numbers of the first single-asset backed security tokens and the second single-asset backed security tokens to be bound by the execution of the vault contract code, a token name of the multi-assets backed security token, a total amount of tokens to be issued, a price per token, a dividend payment period, a time span for which dividends are to be paid, and a token sales closing date.

According to an embodiment of the disclosure, the processor may be operable to present, on the display unit, a graphical user interface for issuing an asset backed security token. The first single-asset backed security token issuance request, the second single-asset backed security token issuance request, and the multi-assets backed security token issuance request may be received through the graphical user interface.

According to an embodiment of the disclosure, the processor may be operable to present, on the display unit, a list including at least one information for the first single-asset backed security token, the second single-asset backed security token, and the multi-assets backed security token, among a token name, an operating revenue, an expected annual interest, a price per token, a total amount of tokens issued, a number of tokens sold, and a time span for which dividends are to be paid.

According to an embodiment of the disclosure, binding of the first number of first single-asset backed security tokens and the second number of second single-asset backed security tokens by the execution of the vault contract code may include, through an execution of the issuance contract code on the blockchain network, transferring the first number of the first single-asset backed security tokens and the second number of second single-asset backed security tokens, respectively, to a token wallet associated with the vault contract code, and transferring sales proceeds corresponding to the transfer of each of the tokens from a digital currency wallet associated with the third token issuer terminal to digital currency wallets associated with the first token issuer terminal and the second token issuer terminal, respectively.

According to an embodiment of the disclosure, binding of the first number of first single-asset backed security tokens and the second number of second single-asset backed security tokens by the execution of the vault contract code may further include transferring a fee corresponding to the transfer of each of the tokens from the digital currency wallet associated with the third token issuer terminal to a digital currency wallet associated with the platform operator device.

According to an embodiment of the disclosure, transferring of the sales proceeds corresponding to the transfer of each of the tokens may include transferring an amount of digital currency calculated based on the price per token and the first number of the first single-asset backed security tokens to be bound from the digital currency wallet associated with the third token issuer terminal to the digital currency wallet associated with the first token issuer terminal and transferring an amount of digital currency calculated based on the price per token and the second number of the second single-asset backed security tokens to be bound from the digital currency wallet associated with the third token issuer terminal to the digital currency wallet associated with the second token issuer terminal.

According to an embodiment of the disclosure, the processor, when receiving an add request to add a fourth number of fourth single-asset backed security tokens to the underlying asset for the multi-assets backed security token from the third token issuer terminal, may enable the vault contract code to be executed on the blockchain network to further bind the fourth number of fourth single-asset backed security tokens to the binding of the first number of first single-asset backed security tokens and the second number of second single-asset backed security tokens according to information in the add request.

According to an embodiment of the disclosure, the further binding of the fourth number of fourth single-asset backed security tokens to the binding of the first number of first single-asset backed security tokens and the second number of second single-asset backed security tokens may lead to a change in at least one of the total number of tokens to be issued or the price per token of the multi-assets backed security token.

According to an embodiment of the disclosure, the processor, when receiving, via the communication network, a purchase request for the first single-asset backed security token from an investor terminal, may enable the issuance contract code to be executed on the blockchain network to support transfer of a number of the first single-asset backed security tokens based on the purchase request to a token wallet associated with the investor terminal and to support transfer of corresponding sales proceeds and fees from an digital currency wallet associated with the investor terminal to each of a digital currency wallet associated with the first token issuer terminal and an digital currency wallet associated with the platform operator device.

According to an embodiment of the disclosure, the processor, when receiving, via the communication network, a purchase request for the multi-assets backed security token from an investor terminal, may enable the vault contract code to be executed on the blockchain network to support transfer of a number of the multi-assets backed security tokens based on the purchase request to a token wallet associated with the investor terminal and to support transfer of corresponding sales proceeds and fees from an digital currency wallet associated with the investor terminal to each of a digital currency wallet associated with the third token issuer and a digital currency wallet associated with the platform operator device.

According to an embodiment of the disclosure, each of the first single-asset backed security token, the second single-asset backed security token, and the multi-assets backed security token may be a real estate revenue security type token.

According to an embodiment of the disclosure, the plurality of smart contract codes may further include a distributor contract code. The processor, when receiving a dividend distribute request for the first single-asset backed security token, may enable the distributor contract code to be executed on the blockchain network to support execution of dividend distribution to each investor terminal associated with the first single-asset backed security token. The distribute request may include a total profit for the first single-asset backed security token.

According to an embodiment of the disclosure, the processor may be operable to present, on the display unit, a graphical user interface for a dividend distribute request for an asset backed security token. The dividend distribute request for the first single-asset backed security token may be received through the graphical user interface.

According to an embodiment of the disclosure, the execution of the dividend distribution to each investor terminal may include, for each investor terminal holding at least one of the first single-asset backed security tokens in an associated token wallet on the blockchain network, determining a dividend based on a ratio of a number of the first single-asset backed security tokens held in the token wallet of the investor terminal to a total token amount of the first single-asset backed security tokens issued and transferring the determined dividend from the digital currency wallet associated with the first token issuer terminal to the digital currency wallet associated with the investor terminal.

According to an embodiment of the disclosure, the execution of the dividend distribution to each investor terminal may include, for each investor terminal holding at least one of the multi-assets backed security tokens in an associated token wallet on the blockchain network, determining a dividend based on a ratio of the first number of the first single-asset backed security tokens bound as the underlying asset of the multi-assets backed security token to a total amount of the first single-asset backed security tokens issued and a ratio of the number of multi-assets backed security tokens held in the token wallet of each investor terminal to a total amount of the multi-assets backed security tokens issued, and transferring the determined dividend from the digital currency wallet associated with the first token issuer terminal to the digital currency wallet associated with the investor terminal.

According to an embodiment of the disclosure, the plurality of smart contract codes may further include a single-asset backed security token liquidator contract code. The platform operator device, when receiving a liquidate request for the first single-asset backed security token, may enable the single-asset backed security token liquidator contract code to be executed on the blockchain network to support execution of liquidation for the first single-asset backed security token.

According to an embodiment of the disclosure, the execution of the liquidation for the first single-asset backed security token may include calculating a total liquidation amount for the liquidation, distributing the total liquidation amount to each relevant investor, and burning all of the first single-asset backed security tokens.

According to an embodiment of the disclosure, the execution of the liquidation for the first single-asset backed security token may include determining a liquidation amount to be distributed to each investor terminal depending on a number of the first single-asset backed security tokens held in the token wallet associated with each investor terminal, transferring each determined liquidation amount from the digital currency wallet associated with the first token issuer terminal to the digital currency wallet of each investor terminal, determining a liquidation amount for the multi-assets backed security token depending on the number of first single-asset backed security tokens bound as the underlying asset for the multi-assets backed security token, transferring a predetermined proportion of the determined liquidation amount for the multi-assets backed security tokens from the digital currency wallet associated with the first token issuer terminal to the digital currency wallet associated with each investor terminal depending on the number of the multi-assets backed security tokens held in the token wallet associated with each investor terminal, and transferring a remaining amount after transferring to the digital currency wallet of each investor terminal, of the total liquidation amount to the digital currency wallet of the third token issuer terminal.

According to an embodiment of the disclosure, the processor may be operable to present, on the display unit, a graphical user interface for liquidating the single-asset backed security token. The liquidate request for the first single-asset backed security token may be received through the graphical user interface.

According to an embodiment of the disclosure, the processor may be further configured to communicate, via the communication unit and a communication network, with one or more fiat currency management financial institution servers managing each fiat currency account associated with each of the one or more token issuer terminals or each of the one or more investor terminals.

### Advantageous Effects

According to embodiments of the disclosure, there may be provided a platform device that supports an issuance and an operation of a new type of financial investment product, specifically a multi-assets baked security token, based on a blockchain. According to an embodiment of the disclosure, through a platform operator device on a token platform, issuance and transaction of various types of securities tokens may be facilitated, and in particular, activation of the securities token markets may be promoted in accordance with the provision of various investment products.

### DESCRIPTION OF DRAWINGS

FIG. 1 is a view illustrating a schematic structure of a token platform 100 that supports an issuance of an asset backed security token, according to an embodiment of the disclosure.

FIG. 2 is a view illustrating exemplary smart contract codes distributed on a blockchain distributed ledger and stored on computing nodes 162 on the blockchain network 160 of FIG. 1, according to an embodiment of the disclosure.

FIG. 3 is a view conceptually illustrating a configuration of each block 300 of a blockchain, which may include a blockchain distributed ledger, stored on each computing node 162 in the blockchain network 160 of FIG. 1, according to an embodiment of the disclosure.

FIG. 4 is a procedural flowchart schematically illustrating a process of issuing single-asset backed security tokens from the token platform 100 of FIG. 1 through a platform operator device 110, according to an embodiment of the disclosure.

FIG. 5 illustrates an interface screen 500 that may be utilized to issue a new single-asset backed security token on the token platform 100, among user interfaces that may be presented for the platform operator on the display of the platform operator device 110 of FIG. 1 according to an embodiment of the disclosure.

FIG. 6 is a view illustrating a security token list presentation screen 600 showing a list of security tokens already issued on the token platform 100, among user interfaces that may be presented for a platform operator on the display of the platform operator device 110 of FIG. 1, according to an embodiment of the disclosure.

FIG. 7 is a procedural flowchart schematically illustrating an exemplary process of purchasing asset backed security tokens that have been issued on the token platform 100, by an investor terminal 150 of FIG. 1, according to an embodiment of the disclosure.

FIGS. 8A through 8D illustrate a series of exemplary screens 800-1 to 800-4, which may be presented through a user interface on the display of an investor terminal 150, while a security token issued on the token platform 100 is purchased, according to an embodiment of the disclosure.

FIG. 9 is a procedural flowchart schematically illustrating a process of issuing multi-assets backed security tokens from the token platform 100 of FIG. 1 through a platform operator device 110, according to an embodiment of the disclosure.

FIG. 10 illustrates an interface screen 1000 of a user interface presented for the platform operator on the display of the platform operator device 110 of FIG. 1, to issue a new multi-assets backed security token on the token platform 100, according to an embodiment of the disclosure.

FIGS. 11A and 11B illustrate exemplary screens 1100-1 and 1100-2 presented on the display of the investor terminal 150, for searching for tokens to purchase after a multi-assets backed security token has been issued through the process illustrated in FIGS. 9 and 10.

FIG. 12 is a procedural flowchart schematically illustrating a process for distributing profits for single-asset backed security tokens issued on the token platform 100 of FIG. 1 via a platform operator device 110, according to an embodiment of the disclosure.

FIG. 13 illustrates an interface screen 1300 presented on the display of the platform operator device 110 of FIG. 1, among user interfaces for a platform operator, to facilitate the distribution of profits for a single-asset backed security token on the token platform 100, according to an embodiment of the disclosure.

FIG. 14 illustrates an exemplary screen 1400 showing a portfolio status, presented on a display of an investor terminal 150 after a profit distribution of single-asset backed security tokens (HRE-SEOUL-001) is made through the process illustrated in FIGS. 12 and 13.

FIG. 15 is a procedural flowchart schematically illustrating a process of performing a liquidation procedure for single-asset backed security tokens issued on the token platform 100 of FIG. 1 via a platform operator device 110, according to an embodiment of the disclosure.

FIG. 16 illustrates an interface screen presented on the display of the platform operator device 110 of FIG. 1, among user interfaces for a platform operator, to perform liquidation of single-asset backed security tokens on the token platform 100.

FIG. 17 illustrates an exemplary screen 1700 showing a portfolio status, presented on a display of an investor terminal 150 after a liquidation of single-asset backed security tokens (HRE-SEOUL-001) is made through the process illustrated in FIG. 15.

FIG. 18 is a procedural flowchart schematically illustrating a process of performing a procedure of adding and binding a new single-asset backed security token as the underlying asset securing the token, via a platform operator device 110, in relation to a multi-assets backed security token issued on the token platform 100 of FIG. 1, according to an embodiment of the disclosure.

FIG. 19 illustrates an interface screen 1900 presented on the display of the platform operator device 110 of FIG. 1, among the user interfaces for the platform operator, according to an embodiment of the disclosure, to proceed with the addition of an underlying asset for a multi-assets backed security token on the token platform 100.

FIG. 20 illustrates an exemplary screen 2000 showing the result of retrieving the changed information of the multi-assets backed security token HRE-MULTI-001 on the display of the investor terminal 150 after 10 HRE-SF-001 tokens are added as the underlying asset for the multi-assets backed security token HRE-MULTI-001 through the process shown in FIGS. 18 and 19.

### MODE FOR CARRYING OUT THE INVENTION

Hereinafter, various embodiments of the disclosure are described in detail with reference to the accompanying drawings. When determined to make the gist of the disclosure unnecessarily unclear, specific descriptions of known functions and configurations are omitted. Further, it should be understood that the following description relates only to an embodiment of the disclosure and is not intended to limit the disclosure.

The terms as used herein are provided merely to describe some embodiments thereof, but are not intended to limit the disclosure. As used herein, the singular forms “a,” “an,” and “the” are intended to include the plural forms as well, unless the context clearly indicates otherwise. As used herein, the term ‘and/or’ should be understood as encompassing any and all possible combinations by one or more of the enumerated items. As used herein, the terms “include,” “have,” and “comprise” are used merely to designate the presence of the feature, component, part, or a combination thereof described herein, but use of the term does not exclude the likelihood of presence or adding one or more other features, components, parts, or combinations thereof.

In embodiments of the disclosure, the term “asset” may refer to any tangible or intangible thing of value that is owned by someone or that may be controlled to produce value, and that has a possessory value that may be converted into money. For example, it should be noted that assets may include, for example, both tangible assets such as real estate, artwork, jewelry, and various in-kind items, as well as intangible assets such as intellectual property rights such as patents and copyrights, and stocks, bonds, etc.

In embodiments of the disclosure, the term “asset backed security token” may refer to a digital token representation of the rights associated with a given asset, such as the right to receive revenue (dividends, operating revenue, etc.) from the given asset itself, or the legal title to transfer the asset itself, and placed on a blockchain network. It should be appreciated that in embodiments of the disclosure, the term “asset backed security token” may also be used to refer collectively to the single-asset backed security token and multi-assets backed security token described below. Meanwhile, while asset backed security tokens are used herein to refer primarily to profitable asset backed security tokens, i.e., security tokens whose right to earn a return from managing the underlying asset is secured by the underlying asset, it should be understood that the disclosure is not limited thereto. In some embodiments of the disclosure, the asset backed security token may secure the ownership of the underlying asset.

In embodiments of the disclosure, a single-asset backed security token may refer to an asset backed security token issued based on a single-asset, wherein the single-asset is not necessarily physically a single asset, but may be a single physical asset or, alternatively, an arbitrary series of assets grouped together into a single unit to form the basis for the issuance of the token. In embodiments of the disclosure, the real-world asset underlying the issuance of a single-asset backed security token may be real estate or other tangible assets, or may be intangible assets, including intellectual property rights such as patents. In embodiments of the disclosure, the single-asset underlying the issuance of a single-asset backed security token may be a bundle of homogeneous or heterogeneous assets.

In embodiments of the disclosure, a multi-assets backed security token may refer to a new asset backed security token issued using a binding of a plurality of single-asset backed security tokens previously issued on the token platform and offered for transaction, as the underlying asset. As used herein, “binding” may refer to a state in which individual single-asset backed security tokens are bound to be the underlying asset of a new multi-assets backed security token or a bundle thereof (thus, a transaction of a multi-assets backed security token will not be a direct transaction of each single-asset backed security token bound to the underlying asset, but rather a transaction of the value of the single-asset backed security token bound to the underlying asset). For example (by way of illustration only), in embodiments of the disclosure, in a state in which a single-asset backed security token A based on a specific asset a (one unit of real estate, e.g., building a) and a single-asset backed security token B based on a specific asset (collection of real estate, e.g., a bundle of apartments called b) have been issued on the token platform, a new multi-assets backed security token may be issued based on binding of a predetermined number of security tokens A and a predetermined number of security tokens B. For example (by way of illustration only), in embodiments of the disclosure, in a state in which a single-asset backed security token A′ based on a specific asset a′ (e.g., one patent right or a series of patent rights) and a single-asset backed security token B′ based on a specific asset b′ (e.g., another patent right or another series of patent rights) have been issued on the token platform, a new multi-assets backed security token may be issued based on binding of a predetermined number of security tokens A′ and a predetermined number of security tokens B′. In other words, a multi-assets backed security token may be said to be based on a bundle of multiple types of tokens (specifically, multiple types of single-asset backed security tokens) already issued on the platform, and indirectly based on each of the multiple assets through each single-asset backed security token in the bundle. Therefore, multi-assets backed security tokens may be considered a kind of derivative in the asset backed security token market.

In embodiments of the disclosure, issuance of an asset backed security token may mean that the token is created on the blockchain network and placed in a state where it may be the subject of a transaction (or purchase), and when an investor purchases some of the issued tokens, the tokens may be transferred to the investor’s token wallet.

Unless otherwise defined, all terms including technical and scientific terms used herein have the same meaning as commonly understood by one of ordinary skill in the art to which the embodiments of the disclosure pertain. It should be understood that commonly used dictionary-defined terms are to be construed to have a meaning consistent with their contextual meaning in the relevant art and are not to be construed to be unduly restrictive or broad unless expressly defined otherwise in the disclosure.

Hereinafter, the disclosure is described in detail with reference to the accompanying drawings.

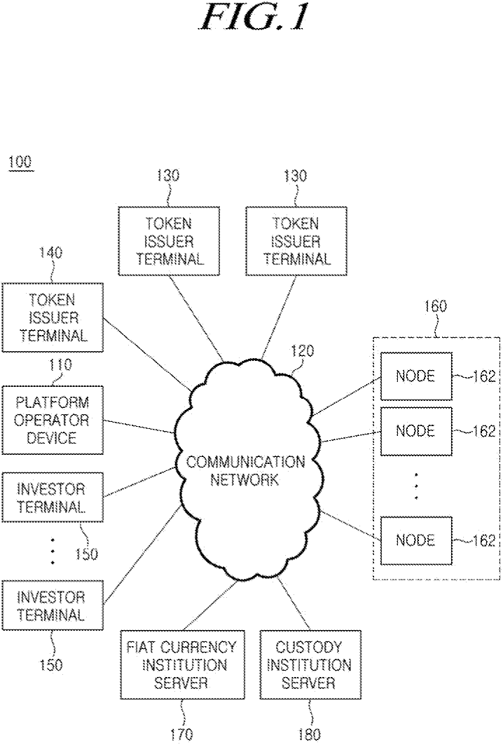

FIG. 1 is a view illustrating a schematic structure of a token platform 100 that supports an issuance of an asset backed security token, according to an embodiment of the disclosure. As shown, the token platform 100 includes a platform operator device 110, a communication network 120, a single-asset backed security token issuer terminal 130, a multi-assets backed security token issuer terminal 140, a plurality of investor terminals 150, a blockchain network 160, a fiat currency institution server 170, and a custody institution server 180. The blockchain network 160 includes a plurality of computing nodes 162 constituting the blockchain network 160.

According to an embodiment of the disclosure, the platform operator device 110 may be a communication device for a platform operator that manages the issuance (and sales) of asset backed security tokens on the token platform 100 and the overall operation (e.g., dividend distribution or liquidation related to issued tokens) of the token platform 100 by invoking and executing various smart contract codes on the blockchain network 160 described below. According to an embodiment of the disclosure, the platform operator device 110 may communicate, via the communication network 120, with other entities on the token platform 100, such as the single-asset backed security token issuer terminal 130, the multiple-assets backed security token issuer terminal 140, each of the plurality of investor terminals 150, each computing node 162 of the blockchain network 160, the fiat currency institution server 170, and/or the custody institution server 180. While, in the disclosure, each of the processes of issuing, purchasing (or selling), dividend distributing, and liquidating of asset backed security tokens is primarily described as being performed through communication between each entity and platform operator device 110 via the communication network 120 and invocation and execution of smart contract codes on blockchain network 160 via the platform operator device 110, the disclosure is not limited thereto. It should be appreciated that, according to embodiments of the disclosure, direct invocation and execution of smart contract codes on the token platform 100 may be performed by entities other than the platform operator device 110.

According to an embodiment of the disclosure, each of the token issuer terminals 130 and 140, each of the investor terminals 150, and the platform operator device 110 may respectively have a digital currency account under the custody of a custody institution associated with them. According to an embodiment of the disclosure, each of the token issuer terminals 130 and 140 and each investor terminal 150 may also respectively have a fiat currency account managed by a fiat currency institution (e.g., a commercial bank, etc.) associated with them. According to an embodiment of the disclosure, each investor terminal 150 may also have a token account associated with it. According to an embodiment of the disclosure, the platform operator device 110 may store and manage information about each digital currency account and/or each fiat currency account associated with each of the token issuer terminals 130 and 140. According to an embodiment of the disclosure, the platform operator device 110 may store and manage information about each digital currency account, each fiat currency account, and/or each token account associated with each investor terminal 150. According to an embodiment of the disclosure, the platform operator device 110 may store and manage information about the digital currency account associated with the platform operator device 110 itself. According to an embodiment of the disclosure, the platform operator device 110 may support each of token issuer terminal 130 and 140 and each investor terminal 150 in subscribing to the token platform 100, during which the platform operator device 110 may obtain and store the respective associated fiat currency account information, electronic currency account information, and/or token account information of each token issuer terminal 130 or 140 and each investor terminal 150. According to an embodiment of the disclosure, the platform operator device 110 may also support conducting a KYC procedure for each investor terminal 150 to support the process of subscribing to the token platform 100, and may allow only an investor (and its investor terminal 150) that is recognized as an eligible investor by such KYC process to subscribe to the token platform 100. No detailed description of the process of supporting KYC is given here.

According to an embodiment of the disclosure, the platform operator device 110 may also support issuance of asset backed security tokens on the token platform 100. According to an embodiment of the disclosure, the platform operator device 110 may receive a token issuance request from the single-asset backed security token issuer terminal 130 or the multiple-assets backed security token issuer terminal 140, and may execute smart contract codes on the blockchain network 160 for issuing the token in response to the received token issuance request. According to an embodiment of the disclosure, the platform operator device 110 may also support the purchase process of an asset backed security token by the investor terminal 150 in response to a request from the investor terminal 150. According to an embodiment of the disclosure, the platform operator device 110 may receive a purchase request for a specific token from the investor terminal 150 and, in response to the received purchase request, execute smart contract codes on the blockchain network 160 to purchase the token.

According to an embodiment of the disclosure, the platform operator device 110 may support the process of distributing profits associated with a single-asset backed security token to each investor. According to an embodiment of the disclosure, the platform operator device 110 may receive a dividend distribute request containing profit information from the single-asset backed security token issuer terminal 130 and, in response to the received dividend distribute request, execute smart contract codes on the blockchain network 160 for distributing the profits/dividends. According to an embodiment of the disclosure, the platform operator device 110 may also support the liquidation process of the asset backed security token in response to a request from the asset backed security token issuers 130 and 140. According to an embodiment of the disclosure, the platform operator device 110 may receive a liquidate request for the token from the asset backed security token issuer terminals 130 and 140, and may execute smart contract codes on the blockchain network 160 in response to the received liquidate request to proceed with the liquidation process.

According to an embodiment of the disclosure, the communication network 120 may be a TCP/IP communication network with, e.g., a peer-to-peer distributed network implemented. According to an embodiment of the disclosure, the communication network 120 may be, e.g., a Wi-Fi network, a LAN network, a WAN network, an Internet network, or the like, but the disclosure is not limited thereto.

According to an embodiment of the disclosure, the single-asset backed security token issuer terminal 130 may be a communication terminal for the token issuer that wishes to issue a single-asset backed security token on the token platform 100 based on a predetermined asset that it owns (or manages). In an embodiment of the disclosure, the single-asset backed security token issuer terminal 130 may transmit, via the communication network 120, to the platform operator device 110 a request for issuance of a single-asset backed security token based on a real-world asset that it owns (or manages). According to an embodiment of the disclosure, the single-asset backed security token issuer terminal 130 may, after issuing a token, transmit a dividend distribute request or a liquidate request for the issued token to the platform operator device 110 via the communication network 120. While only two single-asset backed security token issuer terminals 130 are shown in this figure, it should be appreciated that the disclosure is not limited thereto and that a greater number of single-asset backed security token issuer terminals 130 may be included in the token platform 100.

According to an embodiment of the disclosure, the multi-assets backed security token issuer terminal 140 may be a communication terminal for the token issuer that wishes to bind a plurality of single-asset backed security tokens already issued and offered for transaction on the token platform and issue a new multi-assets backed security token with the result of the binding as the underlying asset. In an embodiment of the disclosure, the multi-assets backed security token issuer terminal 140 may transmit a request to issue a multi-assets backed security token via the communication network 120. While only one multi-assets backed security token issuer terminal 140 is shown in this figure, it should be appreciated that the disclosure is not limited thereto and that a greater number of multi-assets backed security token issuer terminals 140 may be included in the token platform 100.

According to an embodiment of the disclosure, each of the plurality of investor terminals 150 may be a communication terminal for each investor that purchases single-asset backed security tokens or multiple-asset backed security tokens issued on the blockchain network 160 within the token platform 100 and offered for transaction. According to an embodiment of the disclosure, each investor terminal 150 may, via the communication network 120, request, to the platform operator device 110, information about each asset backed security token currently issued on the blockchain network 160 within the token platform 100 and offered for transaction, and may receive response information from the platform operator device 110. According to an embodiment of the disclosure, each investor terminal 150 may include a display device and may present, on the display, response information received from the platform operator device 110, such as information about each asset backed security token issued on the token platform 100 and offered for transaction. According to an embodiment of the disclosure, each investor terminal 150 may transmit, to the platform operator device 110, via the communication network 120, a purchase request for a specific quantity of specific tokens inputted from an investor on the terminal.

According to an embodiment of the disclosure, each of the computing nodes 162 of the blockchain network 160 may be a computing device that communicates peer-to-peer with each other over the communication network 120. Each of these computing nodes 162 may also include smart contract codes that enable various transactions to occur on the token platform 100, such as the issuance, purchase, dividend distribution, and liquidation of tokens, and at least a portion of a blockchain distributed ledger that stores a record of each transaction made by the execution of each smart contract code. According to an embodiment of the disclosure, each computing node 162 may also generate (or mine) and/or verify each block for recording a new transaction record, according to a predefined algorithm. According to an embodiment of the disclosure, transaction records that are generated on the token platform 100 during a predetermined time interval may be stored together in a newly created block and distributed to the computing nodes 162 on the blockchain network 160. In an embodiment of the disclosure, the blockchain network 160 is a private blockchain network and each computing node 162 may be limited to a node authorized to participate in that blockchain network, but the disclosure is not limited thereto. According to other embodiments of the disclosure, the blockchain network 160 may be a public blockchain network and may have no special restrictions on participating nodes.

According to an embodiment of the disclosure, the fiat currency institution server 170 may be a server device of an institution that manages fiat currency, such as a commercially available online or offline bank or securities firm that manage the user’s fiat currency account. As described above, each of the token issuer terminals 130 and 140 and each of the investor terminals 150 may have a fiat currency account associated with each of them and, with the intervention of the fiat currency institution server 170, their fiat currency accounts may be linked to their associated digital currency accounts in accordance with various transactions occurring on the token platform 110. For example, according to an embodiment of the disclosure, in response to a request from each investor terminal 150, the fiat currency institution server 170 may operate to charge an amount of fiat currency to digital currency under the management of a predetermined custody institution associated with that investor terminal 150. While only one fiat currency institution server 170 is shown in this figure, it should be appreciated that the disclosure is not limited thereto and that a greater number of fiat currency institution servers may be included in the platform 100.

According to an embodiment of the disclosure, the custody institution server 180 may be a server of a custody institution that holds and manages the digital currency accounts associated with the entities operating on the token platform 100, such as the token issuer terminals 130 and 140, the investor terminals 150, and the platform operator device 110. According to an embodiment of the disclosure, the custody institution server 180 may perform an exchange procedure in communication with the fiat institution server 170, such that an amount of fiat currency from a fiat currency account is charged to an amount of electronic currency in an associated digital currency account as described above.

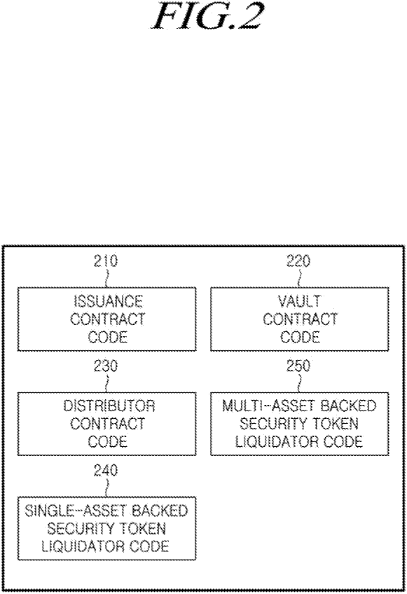

FIG. 2 is a view illustrating exemplary smart contract codes distributed on a blockchain distributed ledger and stored on computing nodes 162 on the blockchain network 160 of FIG. 1, according to an embodiment of the disclosure. As illustrated in the figure, the blockchain distributed ledger of the blockchain network 160 includes, e.g., an issuance contract code 210, a vault contract code 220, a distributor contract code 230, a single-asset backed security token liquidator contract code 240, and a multi-assets backed security token liquidator contract code 250.

According to an embodiment of the disclosure, the issuance contract code 210 receives, as input, a token issuance request to issue a single-asset backed security token and related information, such as, but not limited to, a name of the token, a total amount of tokens to be issued, an operating revenue (profits to be earned by managing the asset), an expected annual interest, a dividend payment period, a total time span for which dividends are to be paid, and a token sales closing date (by way of example only and not limitation). The issuance contract code 210, when executed in response to the token issuance request, may cause a single-asset backed security token based on such input information to be issued (offered for transaction) on the blockchain network 160. According to an embodiment of the disclosure, the issuance contract code 210 may also receive a purchase request for a single-asset backed security token issued on the blockchain network 160. The purchase request may include related information, such as the type of token to be purchased, the quantity, the token wallet information associated with the purchaser (or investor terminal 150), and the digital currency wallet information associated with the purchaser (or investor terminal 150). The issuance request, when executed in response to the purchase request, cause the purchase of the token to be executed based on such input information. For example, tokens of the type and quantity to be purchased may be transferred to the token wallet associated with the purchaser (e.g., investor terminal 150), and correspondingly, a purchase price determined by the per-unit price of the purchased tokens and the quantity purchased may be automatically transferred from the digital currency account associated with the purchaser to the digital currency account associated with the issuer of the tokens (or issuer terminal 130).

According to an embodiment of the disclosure, the vault contract code 220 may receive, as input, a token issuance request to issue a multi-assets backed security token and related information, such as the type and quantity of each single-asset backed security token that will be the underlying asset of the multi-assets backed security token, a token name of the multi-assets backed security token to be issued, a total amount of tokens to be issued, a dividend payment period, a time span for which dividends are to be paid, and a token sales closing date. The vault contract code 220, when executed in response to the token issuance request, may cause the multi-assets backed security token to be issued (offered for transaction) based on such input information. According to an embodiment of the disclosure, when the vault contract code 220 is invoked and executed by the platform operator device 110 to issue a multi-assets backed security token, the issuance contract code 210 may be automatically invoked and executed to purchase a predetermined quantity of each of the identified types of single-asset backed security tokens to build the underlying assets. Execution of such issuance contract code 210 may lead to the process of purchasing tokens as previously described with reference to the purchase of tokens. According to an embodiment of the disclosure, execution of the vault contract code 220 may also cause the single-asset backed security tokens purchased according to the invocation and execution of the above-described issuance contract code 210 to be bound and stored to be the underlying asset of the multi-assets backed security token. According to an embodiment of the disclosure, when the vault contract code 220 is executed based on a request for issuance of a multi-assets backed security tokens that uses, e.g., 10 single-asset backed security tokens A and 20 single-asset backed security tokens B as underlying assets, the issuance contract code 210 may be automatically invoked and executed accordingly, so that the 10 single-asset backed security tokens A and the 20 single-asset backed security tokens B may be purchased and bound, respectively, and stored in connection with the issuer of the corresponding multi-assets backed security token. Upon such purchase, the purchase price of the corresponding tokens may be automatically transferred from the digital currency account of the issuer issuing the multi-assets backed security token to the digital currency account of each single-asset backed security token issuer.

According to an embodiment of the disclosure, the distributor contract code 230 may be a smart contract code that may be invoked to distribute profits to each investor when the single-asset backed security token is a profitable token. According to an embodiment of the disclosure, when the distributor contract code 230 is executed by receiving, as input, a name of the token whose profits are to be distributed, and a total profits (current total profits subject to the current distribution), a corresponding amount of profits may be transferred from the digital currency account associated with the issuer terminal 130 of that token to the digital currency account of each investor holding that token. According to an embodiment of the disclosure, when a distribution is made for the single-asset backed security token A, for example by executing the distributor contract code 230, the distribution dividend for an individual token may be calculated based on the given total profits and the total number of A tokens sold. According to an embodiment of the disclosure, execution of the distributor contract code 230 may enable transfer of the digital currency of the corresponding amount of dividend (i.e., the amount that is determined according to the number of A tokens held and the calculated distribution dividend for the each individual token) of the digital currency account associated with each investor terminal 140 which holds one or more A tokens. According to an embodiment of the disclosure, execution of the distributor contract code 230 may also enable calculation of profits related to the multi-assets backed security token which includes the single-asset backed security token A as part of the underlying assets. When the distributor contract code 230 is executed, the profits related to the multi-assets backed security token may be calculated according to the number of A tokens constituting its underlying asset and the calculated dividend for the individual A token. The calculated profits are transferred from the digital currency account associated with the single-asset backed security token issuer terminal 130 to the digital currency account associated with the multi-assets backed security token issuer terminal 130. Then, according to an embodiment of the disclosure, the vault contract code 220 may be invoked and executed, either automatically or with the intervention of the platform operator device 110, to distribute the profits for the multi-assets backed security token. Execution of the vault contract code 220 may enable calculation of dividend to be given to each multi-assets backed security token based on the total number of issued multi-assets backed security tokens and the calculated profits. Each amount of dividends calculated according to the number of tokens held is transferred to the digital currency account associated with each investor holding the multi-assets backed security tokens.

According to an embodiment of the disclosure, the single-asset backed security token liquidator code 240 may be smart contract code that may be invoked and executed when the issuer of the single-asset backed security token wishes to liquidate that token. According to an embodiment of the disclosure, when the single-asset backed security token liquidator code 240 receives information about the tokens to be liquidated as input and is executed, the overall liquidation amount may be calculated, e.g., based on the total number of tokens sold and the selling price per token. According to an embodiment of the disclosure, execution of the single-asset backed security token liquidator code 240 enables transfer of the liquidation amount according to the number of the single-asset backed security tokens held in each token wallet from the digital currency account associated with the issuer of the single-asset backed security token to each digital currency account associated with each token wallet holding the token (e.g., the digital currency account associated with each investor holding the token in his/her token wallet and, if the token is bound and stored as the underlying assets of the multi-assets backed security token, the digital currency account associated with the issuer of the token) while burning the tokens in each token wallet.

According to an embodiment of the disclosure, the multi-assets backed security token liquidator contract code 250 may be a smart contract code that may be executed to liquidate the issued multi-assets backed security token when the underlying assets backing the multi-assets backed security token have disappeared (e.g., when the respective underlying tokens have been liquidated and burned). According to an embodiment of the disclosure, execution of the multi-assets backed security token liquidator contract code 250 may be invoked and executed by the platform operator device 110, or may be automatically invoked and executed on the blockchain network 160 when all of the underlying assets have disappeared. According to an embodiment of the disclosure, when the multi-assets backed security token liquidator contract code 250 is executed, all of the corresponding multi-assets backed security tokens held in each investor’s token wallet may be burned.

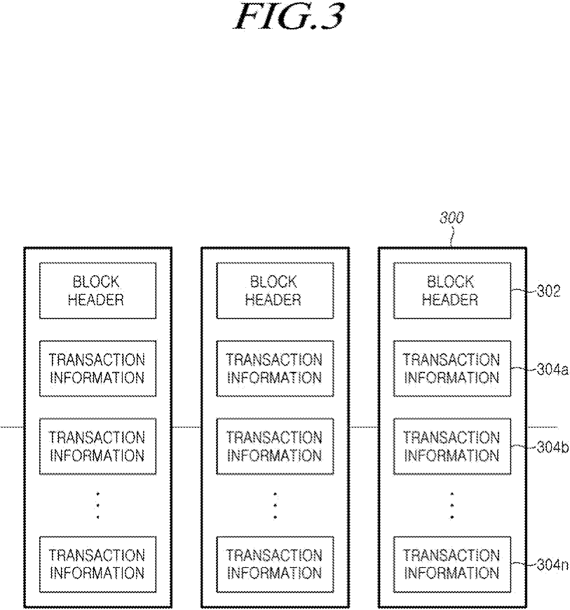

FIG. 3 is a view conceptually illustrating a configuration of each block 300 in a blockchain, which may include a blockchain distributed ledger, stored on each computing node 162 in the blockchain network 160 of FIG. 1, according to an embodiment of the disclosure. As shown, the blockchain includes a plurality of blocks, each block 300 may include a block header 302 and a plurality of transaction information 304a-304n.

According to an embodiment of the disclosure, the block header 302 may include values such as a hash value of the previous block header, a nonce value, a merkle root of the transaction information 304a-304n to be included in the corresponding block 300, a timestamp indicating when the block 300 was generated, and a mining difficulty of the corresponding block 300. According to an embodiment of the disclosure, the plurality of transaction information 304a-304n included in the block 300 may be a plurality of transaction information distributed on the blockchain network 160 from each computing node 162 of FIG. 1 during a predetermined time interval. According to an embodiment of the disclosure, the transaction information 304a-304n of block 300 may include transaction information according to execution of a predetermined smart contract code on the blockchain distributed ledger, such as the issuance, transfer (purchase/sales), distribution, liquidation, and burning of tokens, or information about the accompanying transfer of a predetermined amount of digital currency, by each entity of token platform 100 that supports issuance of asset-backed security tokens, such as platform operator device 110, issuer terminals 130 and 140, and/or investor terminal 150.

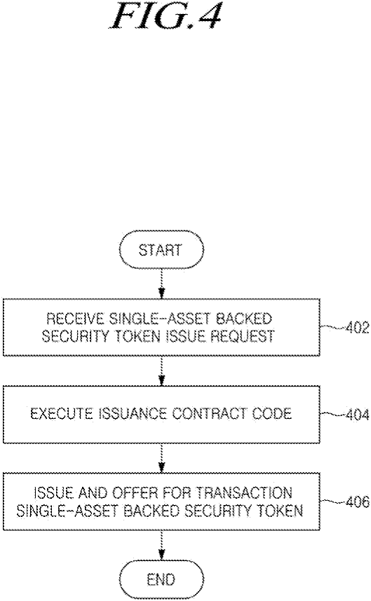

FIG. 4 is a procedural flowchart schematically illustrating a process of issuing single-asset backed security tokens on the token platform 100 of FIG. 1 through a platform operator device 110, according to an embodiment of the disclosure.

According to an embodiment of the disclosure, in step 402, the platform operator device 110 may receive a request for issuance of a single-asset backed security token. According to an embodiment of the disclosure, the above token issuance request may include one or more of the following information: a token name, a total amount of tokens to be issued, an operating revenue, an expected annual interest, a dividend payment period, a time span for which a dividends are to be paid, and a token sales closing date information. According to an embodiment of the disclosure, a single-asset backed security token issuance request (and related information) may be transferred to the platform operator by one of various methods, and such issuance request (and related information) may be entered into the platform operator device 110 by intervention of the platform operator receiving such information. In another embodiment of the disclosure, the above-described token issuance request (and related information) may be transferred directly to the platform operator device 110 via the communication network 120 from the single-asset backed security token issuer terminal 130 that wishes to issue the token.

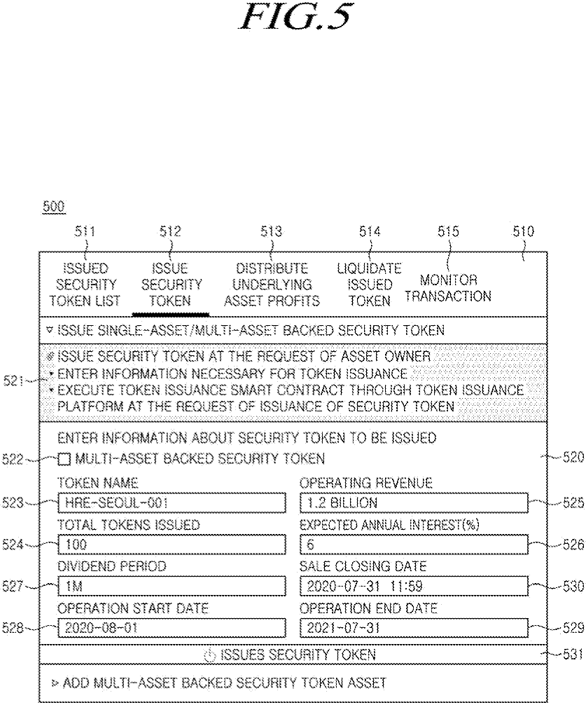

In this regard, FIG. 5 illustrates a user interface screen 500 that may be utilized to issue a new single-asset backed security token on the token platform 100, among user interfaces that may be presented for the platform operator on the display of the platform operator device 110 of FIG. 1, according to an embodiment of the disclosure. According to an embodiment of the disclosure, the user interface that may be presented for the platform operator on the display of the platform operator device 110, as shown in FIG. 5, may basically include a menu bar 510 at the top and a detailed content presentation portion 520 at the bottom. As shown, the menu bar 510 at the top of the screen 500 may include a “issued security token list” item 511, an “issue security token” item 512, a “distribute underlying asset profits” item 513, a “liquidate issued token” item 514, and a “monitor transactions” item 515, but the disclosure is not limited thereto. As described above, this figure illustrates an interface screen 500 that may be utilized to issue a new single-asset backed security token on the token platform 100, wherein the “issue security token” item 512 is selected among the menu items included in the menu bar 510.

Referring to FIG. 5, the detailed content presentation portion 520 at the bottom of the screen 500 presents a statement 521 indicating that the screen is for issuing a security token, and a checkbox 522 for being selected when issuing a multi-assets backed security token. Since this screen 500 is for issuing a single-asset backed security token, it may be seen that checkbox 522 is unchecked. The screen 500 also shows fields in which various information about the newly issued security token on the token platform 100 will be entered by the platform operator, such as the token name field 523 (HRE-SEOUL-001), the total number of tokens to be issued field 524 (100), the operating revenue field 525 (1.2 billion), the expected annual interest field 526 (6%), the revenue dividend payment period field 527 (1 Month), the operation start and end dates fields 528, 529 (2020.08.01-2021.7.31), and the sales closing date field (530) (2020.07.31). At the bottom of the portion 520, a request input portion 531 is shown that, after the above-described information is entered, conveys a request to issue a security token on the blockchain network 160.

Turning back to FIG. 4, according to an embodiment of the disclosure, in step 404, the platform operator device 110 may invoke and execute smart contract code (e.g., the above-described issuance contract code) for issuing a single-asset backed security token on the blockchain network 160. According to an embodiment of the disclosure, the platform operator may invoke and execute the issuance contract code on the blockchain network 160 by clicking on the request input portion 531 of the screen 500, e.g., after entering information for issuing tokens via the interface screen 500 of FIG. 5.

Then, in step 406, upon execution of the issuance contract code, a new single-asset backed security token may be issued on the blockchain network 160 and recorded on the blockchain distributed ledger. The newly minted single-asset backed security token may now be placed in the state offered for transaction.

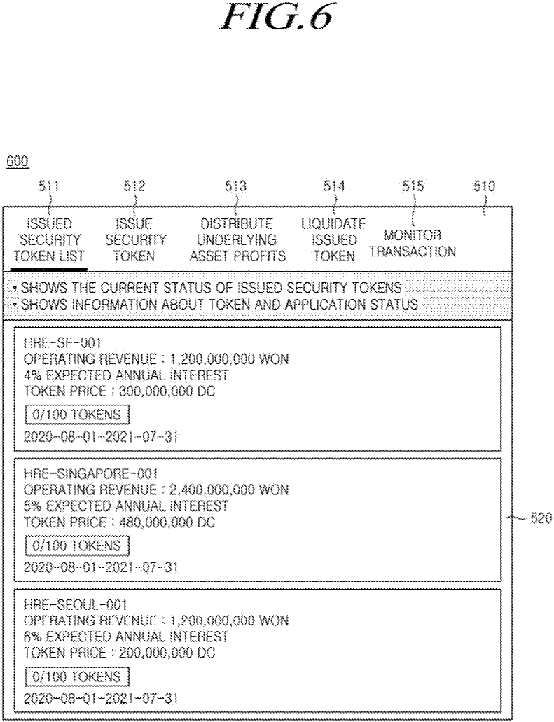

FIG. 6 is a view illustrating a security token list presentation screen 600 showing a list of security tokens issued on the token platform 100, in accordance with an embodiment of the disclosure, on the display of the platform operator device 110 of FIG. 1, among user interfaces that may be presented for the platform operator. Thus, on screen 600, it may be identified that the “issued security token list” item 511 is currently selected from among the menu items included in menu bar 510.

In the detailed content presentation portion 520 at the bottom of screen 600, each type of security token currently issued and offered for transaction on the token platform 100 is presented. As shown, at the portion 520, three types of pre-issued security tokens are presented on the token platform 100, namely HRE-SF-001, HRE-SINGAPORE-001, and HRE-SEOUL-001 (HRE-SEOUL-001 may be identified as a newly issued security token through the process described above with reference to FIGS. 4 and 5, and the other two types of single-asset backed security tokens, namely HRE-SF-001 and HRE-SINGAPORE-001, are assumed to have already been issued on the token platform 100). Further, the figure shows, for each type of token, the name of token (e.g., HRE-SF-001, HRE-SINGAPORE-001, HRE-SEOUL-001), the operating revenue, the expected annual interest, the total number of tokens issued, the price per token determined accordingly (in the figure, the price per token is shown in DC units, which is an arbitrary exemplary digital currency unit (in other embodiment of the disclosure, the price per token may be expressed in units of Ethereum, but the disclosure is not limited thereto), the amount of tokens already sold, and the investment operation period.

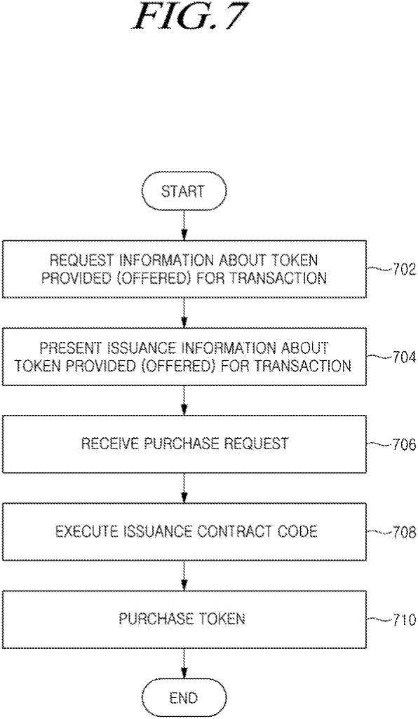

FIG. 7 is a procedural flowchart schematically illustrating an exemplary process of purchasing asset backed security tokens that have been issued on the token platform 100 by an investor terminal 150 of FIG. 1, according to an embodiment of the disclosure.

According to an embodiment of the disclosure, in step 702, the investor terminal 150 may request information about asset backed security tokens that have been issued on the token platform 100 and are currently being offered for transaction. Then, in step 704, the investor terminal 150 may receive a response to the request of step 702, i.e., information regarding the asset backed security tokens being offered in the current transaction, and may present the received information on the display on the investor terminal 150.

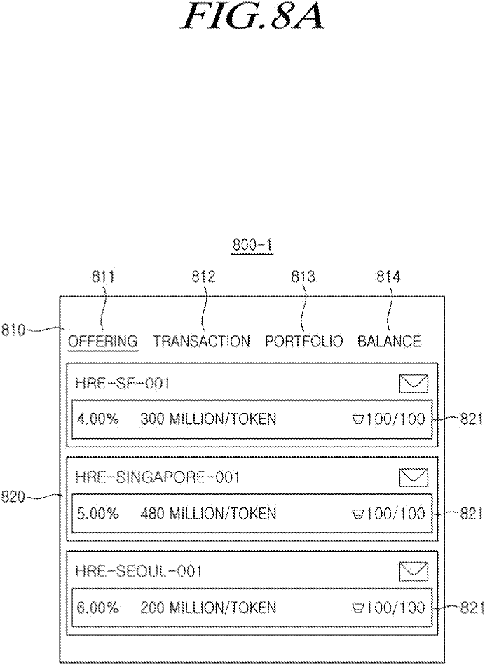

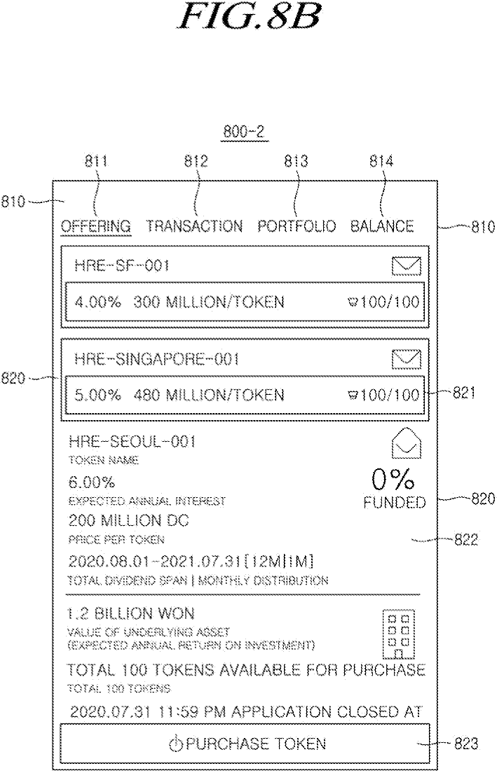

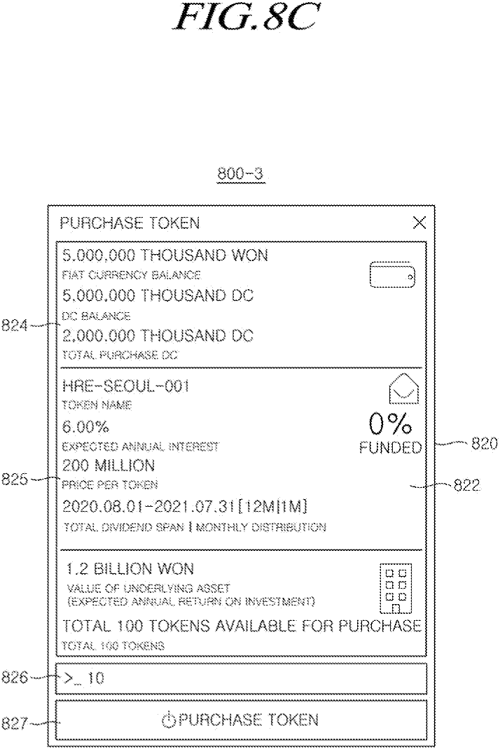

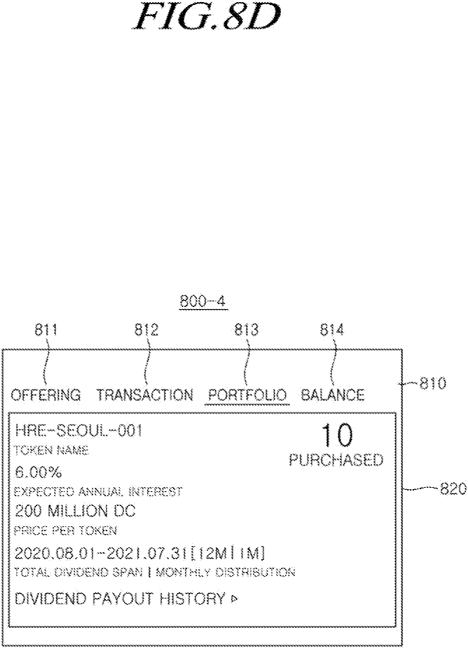

In this regard, FIGS. 8A through 8D depict a series of exemplary screens 800-1 through 800-4 that may be utilized while a security token issued on the token platform 100 is purchased by the investor, among user interfaces for investors that may be presented on the display of the investor terminal 150, according to an embodiment of the disclosure.

First, screen 800-1 of FIG. 8A shows an exemplary screen where, in step 704, information regarding an asset backed security tokens currently being offered for transaction is received on investor terminal 150 and the received information is presented on the display. The illustrated exemplary screen 800-1 includes a menu bar 810 at the top and a detailed content presentation portion 820 at the bottom. As shown, the menu bar 810 at the top of screen 800-1 may include an “offering” item 811, a “transaction” item 812, a “portfolio” item 813, and a “balance” item 814, but the disclosure is not limited thereto. As shown, for the screen 800-1, it may be identified that the “offering” item 811 is selected among the menu items included in menu bar 810.

In the detailed content presentation portion 820 at the bottom of the screen 800-1, each type of security token issued and offered for transaction on the token platform 100 is presented. As shown, at portion 820, three pre-issued security tokens are presented on the token platform 100: HRE-SF-001, HRE-SINGAPORE-001, and HRE-SEOUL-001. Further, the figure may show, for each token type, the name of the token (e.g., HRE-SF-001, HRE-SINGAPORE-001, HRE-SEOUL-001), the expected annual interest, the price per token, the total number of tokens issued, and the number of tokens available for sales.

Screen 800-2 of FIG. 8B illustrates a case in which, when one of the asset backed security tokens presented in screen 800-1 is selected, detailed information regarding the selected security token is presented on the display. Comparison between the screen 800-2 of FIG. 8B to the screen 800-1 of FIG. 8A reveals that while the top menu bar 810 of screen 800-2 is the same as that presented on the screen 800-1, the content presented in the portion 820 on the screen 800-1 is different from that on the screen 800-2. On the screen 800-1, only brief information 821 regarding each of the three types of security tokens is presented, while on the screen 800-2, detailed information regarding HRE-SEOUL-001, which is selected on the investor terminal 150, such as the token name, the expected annual interest, the price per token, a total dividend time span and the dividend payment period, a value of the underlying asset (expected annual operating revenue), a total amount of tokens available for purchase, a sales closing date, and an amount invested so far, etc.), is also displayed across a large area portion 822 below the corresponding brief information portion 821. Further, below the portion 822, a button 823 is provided to select to proceed with the purchase for the selected token HRE-SEOUL-001.

Returning to FIG. 7, in step 706, one type of security token may be selected on the investor terminal 150 and a purchase request for it may be entered, and then in step 708, smart contract code (e.g., issuance contract code) may be invoked and executed to proceed with the requested purchase. In step 710, a token purchase transaction by the corresponding investor terminal 150 (and the associated investor) may be established according to the execution of the smart contract code.

In this regard, screen 800-3 in FIG. 8C is an exemplary screen that may be presented on the investor terminal 150 when an intent to purchase the selected token, e.g., HRE-SEOUL-001, whose detailed information was displayed on the screen 800-2, is entered via button 823. On the screen 800-3 of FIG. 8C, the menu bar presented on the screens 800-1 and 800-2 has disappeared. At the top of the screen 800-3, the investor’s balance information 824 is presented. The detailed information 825 about the selected token HRE-SEOUL-001 presented on the screen 800-2, a purchase quantity input field 826, and a final purchase button 827 are also presented on the screen 800-3. According to an embodiment of the disclosure, when a purchase quantity (e.g., 10) is entered via the purchase quantity input field 826 from the investor, the balance information 824 may display purchase price information according to the purchase quantity entered to the purchase quantity input field 826, along with the fiat currency account balance and the digital currency (DC) account balance associated with the investor terminal 150 (or investor). When the final purchase button 827 is selected on the investor terminal 150, smart contract code, e.g., issuance contract code, may be invoked and executed on the blockchain network 160 to allow the corresponding token purchase to proceed. According to execution of the issuance contract code, a predetermined purchase price may be transferred from the digital currency (DC) account associated with the investor terminal 150 to the digital currency account associated with the issuer terminal 130 for the corresponding token, and a predetermined number of tokens may be simultaneously transferred to the token account associated with the investor terminal 150.

Referring to screen 800-4 in FIG. 8D, it may be identified that the menu bar 810 appears back at the top, and the “portfolio” item 813 is selected among the menu items. In the detailed content presentation portion 820 at the bottom of the screen 800-4, the token holding status of the token account associated with the corresponding investor terminal 150 is presented. As shown, the portion 820 indicates that 10 newly purchased HRE-SEOUL-001 tokens are being hold.

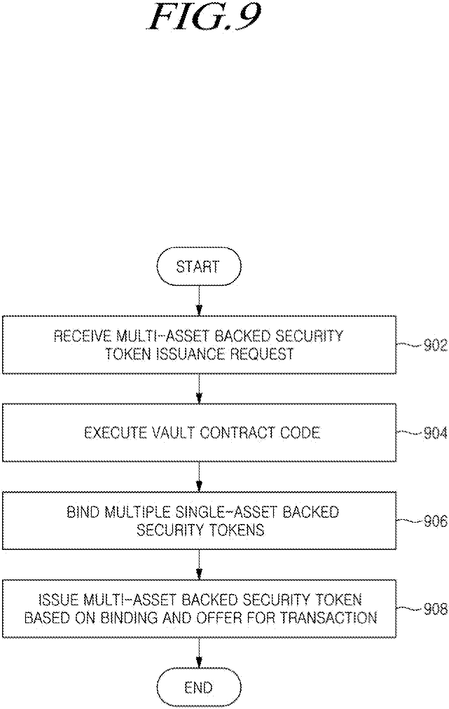

FIG. 9 is a procedural flowchart schematically illustrating a process of issuing multi-assets backed security tokens at the token platform 100 of FIG. 1 through a platform operator device 110, according to an embodiment of the disclosure.

According to an embodiment of the disclosure, in step 902, the platform operator device 110 may receive a request for issuance of a multi-assets backed security token. According to an embodiment of the disclosure, the token issuance request may include information about the multi-assets backed security tokens to be newly issued, such as one or more of the following information: a token name, a total amount of tokens to be issued, an expected annual interest, a dividend payment period, a total dividend payment time span, and a sales closing date information; as well as the names and numbers of the two or more single-asset backed security tokens that will be bound to form the underlying assets for the multi-assets backed token issuance. According to an embodiment of the disclosure, a multi-assets backed security token issuance request (and related information) may be transferred to the platform operator by one of various methods, and such issuance request (and related information) may be entered into the platform operator device 110 by intervention of the platform operator receiving such information. In another embodiment of the disclosure, the above-described token issuance request (and related information) may be transferred directly to the platform operator device 110 via the communication network 120 from the multi-assets backed security token issuer terminal 130 that wishes to issue the token.

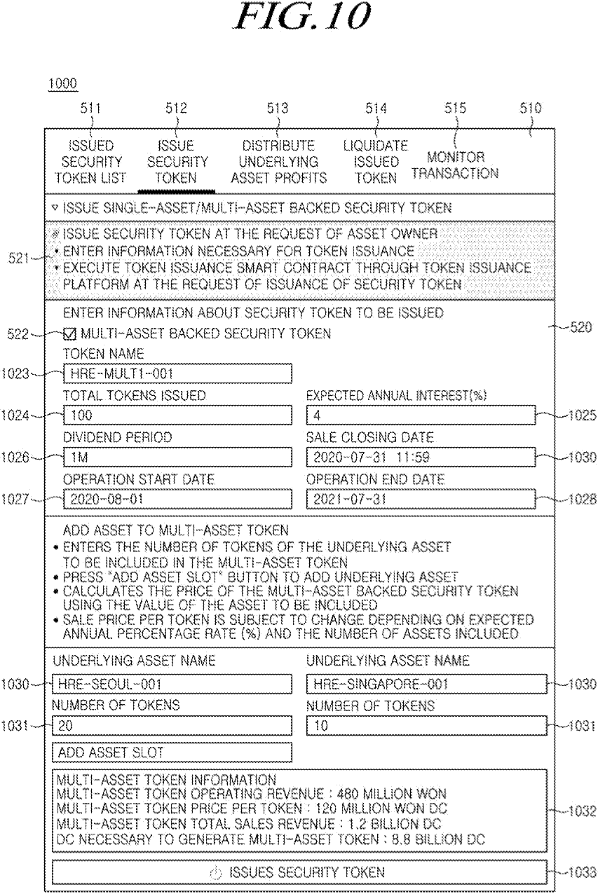

In this regard, FIG. 10 illustrates an interface screen 1000 of a user interface presented for the platform operator on the display of the platform operator device 110 of FIG. 1, to issue a new multi-assets backed security token on the token platform 100, according to an embodiment of the disclosure. According to an embodiment of the disclosure, the user interface presented for the platform operator on the display of the platform operator device 110, as shown in FIG. 10, may basically include a menu bar 510 at the top and a detailed content presentation portion 520 at the bottom, as described above in connection with FIG. 5. As shown, on screen 1000, it may be identified that the “issue security token” item 512 is currently selected among the menu items included in menu bar 510.

Referring to FIG. 10, the detailed content presentation portion 520 at the bottom of the screen 1000 presents a statement 521 indicating that the screen is for issuing a security token, and a checkbox 522 for being selected when issuing a multi-assets backed security token. Since this screen 1000 is for issuing a multi-assets backed security token, it may be seen that checkbox 522 is checked. The screen 1000 also shows fields in which various information about the newly issued multi-assets backed security token on the token platform 100 will be entered by the platform operator, such as the token name field 1023 (HRE-MULTI-001), the total number of tokens to be issued field 1024 (100), the expected annual interest field 1025 (4%), the revenue dividend payment period field 1026 (1M), the operation start and end dates fields 1027, 1028 (2020.08.01-2021.7.31), and the sales closing date field (1030) (2020.07.31). The bottom portion 520 of the screen 1000 also shows a portion where information regarding the single-asset backed security tokens that will be the underlying assets of the newly issued multi-assets backed security tokens is entered, such as a name field 1030 and a quantity field 1031 for each underlying asset (the single-asset backed security tokens that will constitute the underlying assets). According to an embodiment of the disclosure, when the name and quantity of each of the single-asset backed security tokens to be bound as the underlying assets for forming the multi-assets backed security token are entered, as shown in FIG. 10, information related to the multi-assets backed security token information may be automatically determined and displayed in the box 1032 at the bottom of the screen 1000. For example, as illustrated in the figure, the box 1032 includes information such as the operating revenue of the newly issued multi-assets backed security token, the price per token, the gross sales revenue, and the amount of money (in digital currency units) required to create the multi-assets backed security token, but the disclosure is not limited thereto. At the bottom of portion 520 of the screen 1000 is shown a request input portion 1033 that, after the above-described information is entered, transfers a request to issue a multi-assets backed security token on the blockchain network 160.

Turning back to FIG. 9, according to an embodiment of the disclosure, in step 904, the platform operator device 110 may invoke and execute smart contract code (e.g., vault contract code) for issuing a multi-assets backed security token on the blockchain network 160. According to an embodiment of the disclosure, the platform operator may invoke and execute vault contract code on the blockchain network 160 by clicking on the request input portion 1033 of the screen 1000, e.g., after entering information for issuing tokens via the interface screen 1000 of FIG. 10.

In step 906, according to execution of the vault contract code (including resultant execution of the issuance contract code), each of the single-asset backed security tokens as the underlying asset of the multi-assets backed security token may be bound. For example, as described above, according to execution of the vault contract code, a designated number of single-asset backed security tokens for each type may be purchased, bound together and stored in a designated token account associated with the vault contract code (e.g., the token account of the multi-assets backed security token issuer), and simultaneously, the purchase price of each corresponding single-asset backed security token may be transferred from the multi-assets backed security token issuer’s digital currency account to each single-asset backed security token issuer’s digital currency account. The procedure then proceeds to step 908, where a new multi-assets backed security token, based on the bound underlying assets, may be issued and recorded on the blockchain distributed ledger. The newly issued multi-assets backed security token may now be placed in the state offered for transaction.

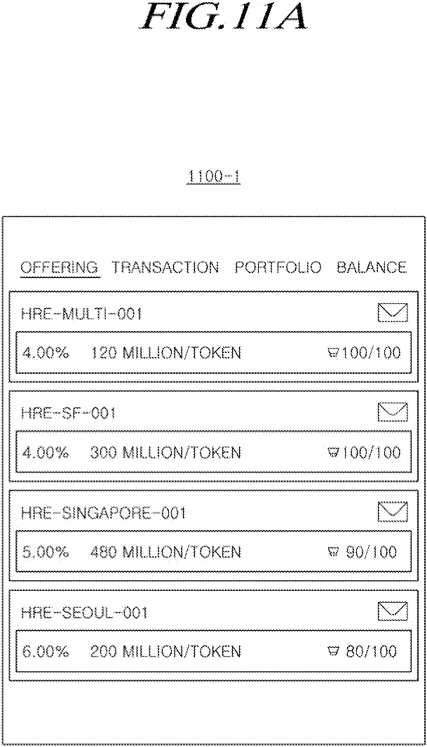

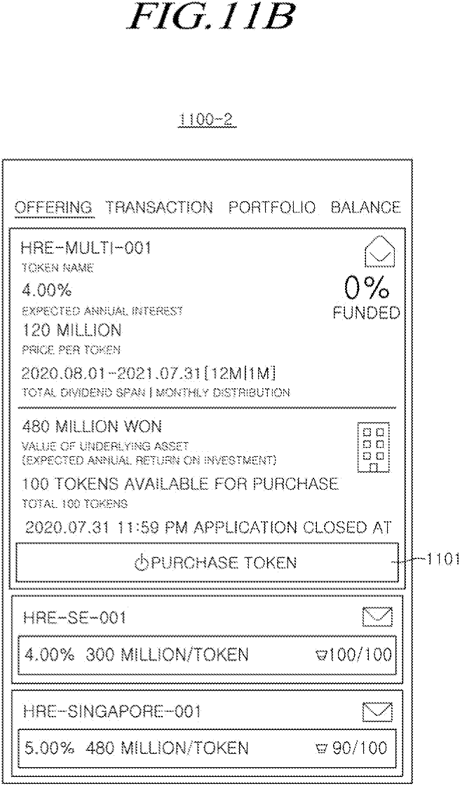

FIGS. 11A and 11B illustrate exemplary screens 1100-1 and 1100-2 presented on the display of the investor terminal 150, for searching for tokens to purchase after the multi-assets backed security token has been issued through the process illustrated in FIGS. 9 and 10.

First, screen 1100-1 of FIG. 11A shows an exemplary screen where information regarding asset backed security tokens currently being offered for transaction is received on investor terminal 150 and the received information is presented on the display. The illustrated exemplary screen 1100-1 is largely similar to the screen 800-1 of FIG. 8A, except that at the top of the screen 1100-1, a newly issued multi-assets backed security token, i.e., HRE-MULTI-001, is further presented which was not present on the screen 800-1 of FIG. 8A, and 10 tokens and 20 tokens for the single-asset backed security tokens HRE-SINGAPORT-001 and HRE-SEOUL-001, respectively, which constitute the underlying assets of HRE-MULTI-001, are shown as having been sold. Screen 1100-2 of FIG. 8B illustrates a case in which, when the above-described multi-assets backed security token HRE-MULTI-001 among the asset backed security tokens presented on the screen 1100-1 is selected, detailed information regarding the selected security token is presented on the display. On the screen 1100-2 of FIG. 8B, detailed information about HRE-MULTI-001 (e.g., token name, annual interest, price per token, total dividend payment time span and dividend payment period, value of underlying assets (annual operating revenue), total amount of tokens available for purchase, sales closing date, etc.) is displayed, and a button 1101 to select to proceed with the purchase of the selected token HRE-MULTI-001 is provided thereunder. The display presentation screen on the investor terminal 150 according to the subsequent purchase process may refer to the screens of FIGS. 8A and 8D above, and is not described below.

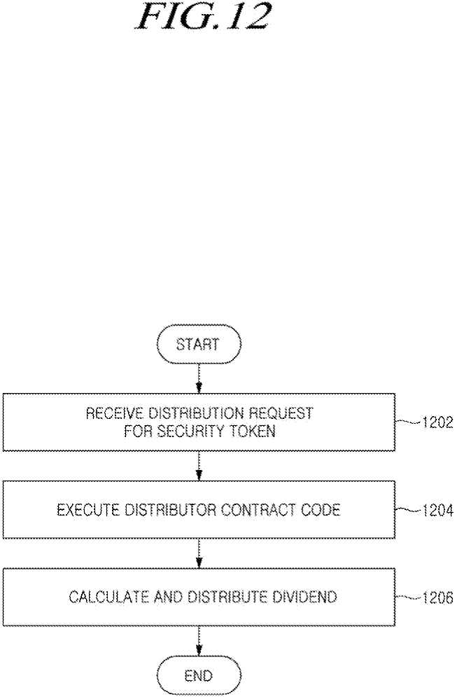

FIG. 12 is a procedural flowchart schematically illustrating a process for distributing profits from single-asset backed security tokens issued on the token platform 100 of FIG. 1 via a platform operator device 110, according to an embodiment of the disclosure.

According to an embodiment of the disclosure, in step 1202, the platform operator device 110 may receive a request to distribute profits for the single-asset backed security tokens. According to an embodiment of the disclosure, a dividend distribute request related to the single-asset backed security tokens may be transferred to the platform operator by one of various methods, and such dividend distribute request may be entered into the platform operator device 110 by intervention of the platform operator receiving the information. According to another embodiment of the disclosure, the above-described dividend distribute request may be transferred directly via the communication network 120 from the single-asset backed security token issuer terminal 130 seeking a dividend distribution to the platform operator device 110. It should be appreciated that, according to an embodiment of the disclosure, a request for distributing profits need not necessarily originate from the single-asset backed security token issuer or his terminal 130, but may be automatically generated on the platform operator device 110 every dividend payment period predetermined when the token is issued.

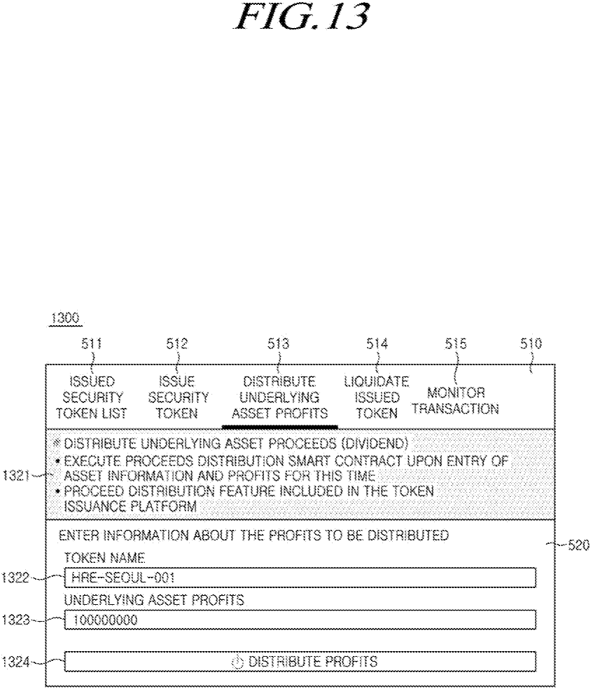

In this regard, FIG. 13 illustrates an interface screen 1300 presented on the display of the platform operator device 110 of FIG. 1, among user interfaces for the platform operator, to facilitate the distribution of profits for a single-asset backed security token on the token platform 100, according to an embodiment of the disclosure. According to an embodiment of the disclosure, the user interface that may be presented for the platform operator on the display of the platform operator device 110, as shown in FIG. 13, may basically include a menu bar 510 at the top and a detailed content presentation portion 520 at the bottom, as described above in connection with FIG. 5. As shown, on screen 1300, it may be identified that the “distribute underlying asset profits” item 513 is currently selected from among the menu items included in menu bar 510.

Referring to FIG. 13, the detailed content presentation portion 520 at the bottom of the screen 1300 presents a statement 1321 indicating that the screen is for the distribution of profits (dividends) from the underlying assets. The screen 1300 also shows fields for entering information about the single-asset backed security tokens whose profits are to be distributed on the token platform 100, subject to the intervention of the platform operator, such as a token name field 1322 (HRE-SEOUL-001) and a total profits input field 1323 (100 million DC). At the bottom of portion 520 of the screen 1300 is shown a request input portion 1324 that, after the above-described information is entered, transfers a request to distribute profits related to the asset backed security tokens on the blockchain network 160.

Turning back to FIG. 12, according to an embodiment of the disclosure, in step 1204, the platform operator device 110 may invoke and execute smart contract code (e.g., distributor contract code) for distributing profits related to the single-asset backed security tokens on the blockchain network 160. According to an embodiment of the disclosure, the platform operator may invoke and execute distributor contract code on the blockchain network 160 by clicking on the request input portion 1324 of the screen 1300, e.g., after entering information for distributing proceeds via the interface screen 1300 of FIG. 13.

In step 1206, according to execution of the distributor contract code, the amount of profits to be given for each token of the corresponding single-asset backed security tokens out of the total profits may be automatically calculated, and the corresponding amount of profits (dividends) may be automatically transferred from the digital currency account associated with the corresponding single-asset backed security token issuer terminal 130 to each token wallet holding one or more corresponding single-asset backed security tokens. For example, for each investor who holds one or more single-asset backed security tokens, which are currently subject to a distribution, in their token wallet, the profits may be transferred to their respective associated digital currency accounts, in proportion to the number of tokens held. For each investor who holds in his or her token wallet at least one multi-assets backed security token (e.g., the multi-assets backed security token HRE-MULTI-001 issued in accordance with the procedures described in connection with the preceding drawings, by including 20 single-asset backed security tokens HRE-SEOUL-001 as underlying assets) that has, as its underlying assets, the single-asset backed security tokens that are currently subjected to the distribution, the profits determined according to the number of the single-asset backed security tokens bound as the underlying assets constituting the multi-assets backed security tokens and the number of such multi-assets backed security tokens held in their token wallet by the investor holding such multi-assets backed security tokens may be transferred to their respective associated digital currency accounts. For example, an investor who owns 10 HRE-MULTI-001s (total issuance of 100), which have been issued by including 20 HRE-SEOUL-001s (total issuance of 100) as part of the underlying assets would be entitled to 20/100 * 10/100 of the total profits.

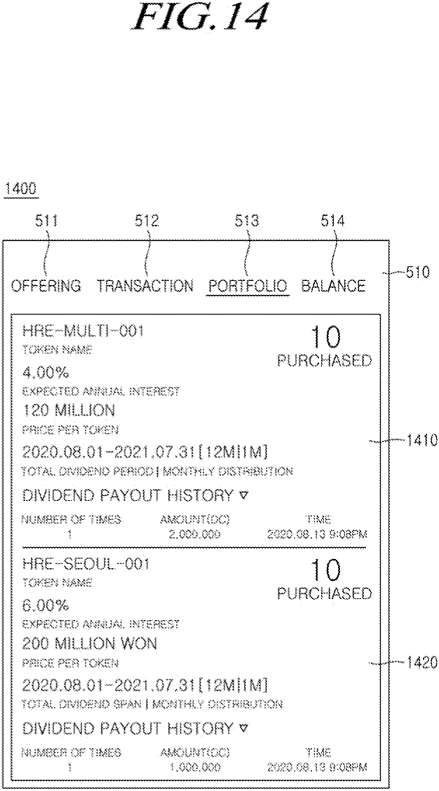

FIG. 14 illustrates an exemplary screen 1400 showing a portfolio status, presented on the display of an investor terminal 150 after a distribution of single-asset backed security tokens (HRE-SEOUL-001) is made through the process illustrated in FIGS. 12 and 13. As shown, at the top portion 1410 of the screen 1400, the investor has now purchased and holds 10 multi-assets backed security tokens HRE-MULTI-001, and receives a one-time dividend of 2 million DC (which is 2% of the total profits of 100 million DC entered by the platform operator device 130 in FIG. 13). The dividend of 2% is derived from the ratio of the number of the HRE-MULTI-001 (10) owned by the investor to the total number of the tokens (100), i.e., 10%, and the ratio of 20 HRE-SEOUL-001 tokens bound as the underlying assets to the 100 to the total number of HRE-SEOUL-001 tokens, i.e., 20%. Further, at the bottom portion 1420 of the screen 1400, it is shown that the investor has purchased and holds 10 HRE-SEOUL-001 tokens and receives a one-time dividend of 10 million DC (which is 10% of the total profits of 100 million DC entered by the platform operator device 130 in FIG. 13, corresponding to 10 tokens held by the investor out of the total number of 100 tokens) in the dividend distribution status portion. Although not specifically shown, it may be identified that the balance in the digital currency account associated with the corresponding investor terminal 150 has increased, when clicking on balance item 514 in the menu bar 510 of the screen 1400.

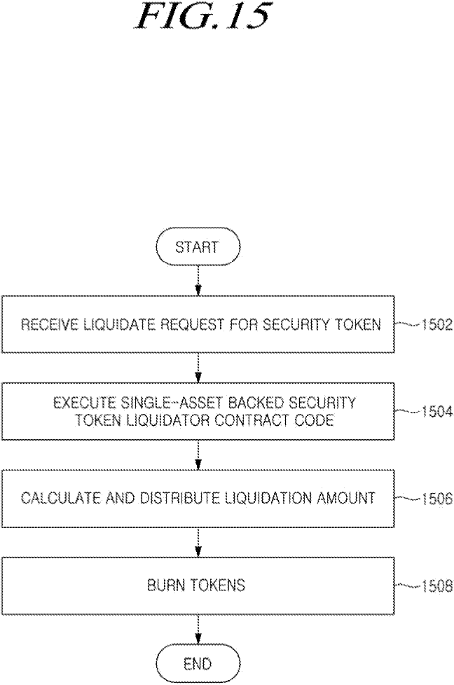

FIG. 15 is a procedural flowchart schematically illustrating a process of performing a liquidation procedure for single-asset backed security tokens issued on the token platform 100 of FIG. 1 via a platform operator device 110, according to an embodiment of the disclosure.

According to an embodiment of the disclosure, in step 1502, the platform operator device 110 may receive a request to liquidate for the single-asset backed security tokens. According to an embodiment of the disclosure, a liquidate request related to the single-asset backed security tokens may be transferred to the platform operator by one of various methods, and such liquidate request may be entered into the platform operator device 110 by intervention of the platform operator receiving the information. According to another embodiment of the disclosure, the above-described liquidate request may be transferred directly via the communication network 120 from the single-asset backed security token issuer terminal 130 seeking liquidation to the platform operator device 110. It should be appreciated that, according to an embodiment of the disclosure, a liquidate request need not necessarily originate from the single-asset backed security token issuer or his terminal 130, but may be automatically generated on the platform operator device 110 at a predetermined operation end date when the token is issued.

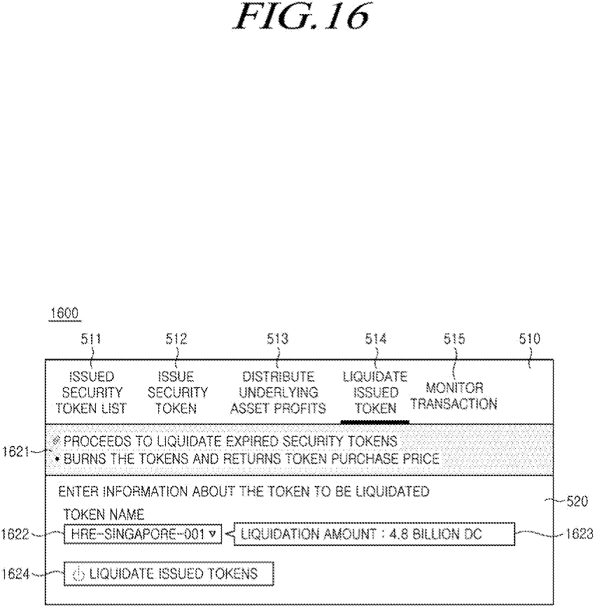

In this regard, FIG. 16 illustrates an interface screen 1600 presented on the display of the platform operator device 110, among user interfaces for a platform operator, to perform liquidation of single-asset backed security tokens on the token platform 100. According to an embodiment of the disclosure, the user interface that may be presented for the platform operator on the display of the platform operator device 110, as shown in FIG. 16, may basically include a menu bar 510 at the top and a detailed content presentation portion 520 at the bottom, as described above in connection with FIG. 5. As shown, on screen 1600, it may be identified that the “liquidate issued token” item 514 is currently selected among the menu items included in menu bar 510.

Referring to FIG. 16, the detailed content presentation portion 520 of the screen 1600 presents a statement 1621 indicating that the screen is for liquidating tokens. The portion 520 also shows fields into which information about the single-asset backed security tokens to be liquidated on the token platform 100 is entered by intervention of the platform operator, such as the token name field 1622 (HRE-SINGAPORE-001). As illustrated in the figure, when a specific name is entered or selected in the token name field 1622, the total liquidation amount, which is necessary to liquidate the tokens, is automatically calculated and presented, like 1623. For example, the liquidation amount may be calculated based on the total number of tokens sold and the price per token, but the disclosure is not limited thereto. In the example shown in the figure, the previously issued HRE-SINGAPORE-001 is liquidated, and a total liquidation amount of 4.8 billion DC is shown. At the bottom of portion 520 of the screen 1600 is shown a request input portion 1624 that, after the above-described information is entered, transfers a request to liquidate the asset backed security tokens on the blockchain network 160.

Referring back to FIG. 15, according to an embodiment of the disclosure, in step 1504, the platform operator device 110 may invoke and execute smart contract code (e.g., single-asset backed security token liquidator contract code) for liquidating the single-asset backed security tokens on the blockchain network 160. According to an embodiment of the disclosure, the platform operator may invoke and execute liquidator contract code on the blockchain network 160 by clicking on the request input portion 1624 of the screen 1600, e.g., after entering liquidation information via the interface screen 1600 of FIG. 16.

In step 1506, according to execution of the liquidator contract code, the liquidation amount to be given to each holder of the corresponding single-asset backed security tokens out of the total liquidation amount may be automatically calculated, and the corresponding liquidation amount may be automatically transferred from the digital currency account associated with the corresponding single-asset backed security token issuer terminal 130 to the digital currency wallet of each token holder. Further, in conjunction therewith, in step 1508, the corresponding tokens may be burned from each token holder’s token wallet. For example, for each investor who holds the single-asset backed security tokens (e.g., HRE-SINGAPORE-001), which is currently subject to liquidation, in their token wallet, a liquidation amount proportional to the number of tokens held may be transferred to each investor’s digital currency account. For each investor who holds in his or her token wallet at least one multi-assets backed security token (e.g., a multi-assets backed security token HRE-MULTI-001 issued in accordance with the procedures described in connection with the preceding drawings, by including 10 single-asset backed security tokens HRE-SINGAPORE-001 as underlying assets), the liquidation amount determined according to the number of the single-asset backed security tokens bound as the underlying assets constituting the multi-assets backed security tokens and the number of such multi-assets backed security tokens held in the investor’s token wallet may be transferred to their respective associated digital currency accounts. It should be obvious that the transfer of liquidation amount entails the burning of the tokens.

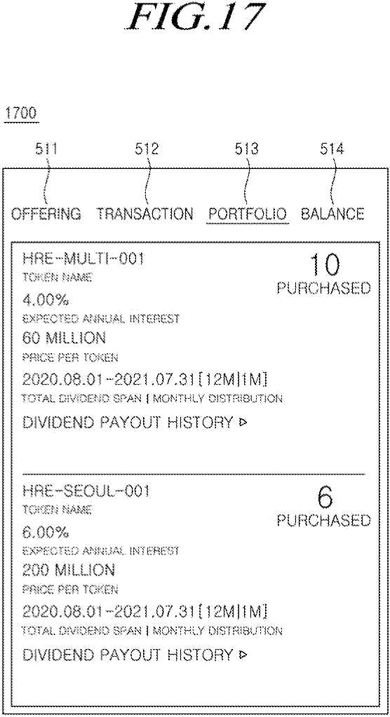

FIG. 17 illustrates an exemplary screen 1700 showing a portfolio status, presented on a display of the investor terminal 150 after the liquidation of single-asset backed security tokens (HRE-SINGAPORE-001) is made through the process illustrated in FIG. 15. The screen 1700 of FIG. 17 is essentially similar to the screen 1400 of FIG. 14, except that the token price per HRE-MULTI-001 token has changed to 60 million DC, as opposed to 120 million DC previously. The change in the price per token is due to the liquidation of HRE-SINGAPORE-001 which constitutes the underlying asset of HRE-MULTI-001. Although not specifically shown, it may be identified that the balance in the digital currency account associated with the corresponding investor terminal 150 has been increased by liquidation of HRE-SINGAPORE-001, when clicking on balance 514 in the menu bar 510 of the screen 1700.

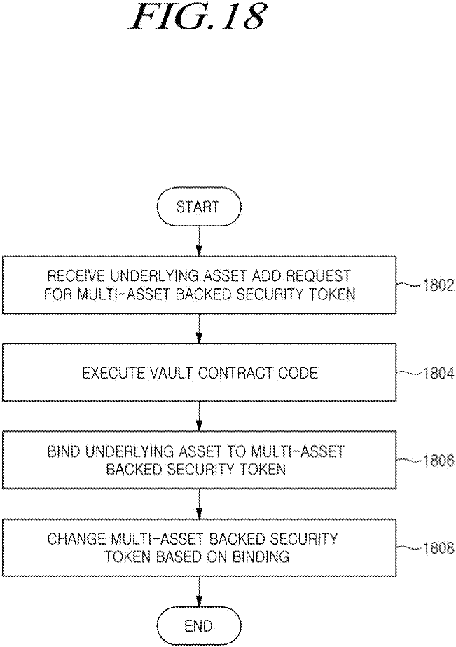

FIG. 18 is a procedural flowchart schematically illustrating a process of performing a procedure of adding and binding a new single-asset backed security token as the underlying asset securing the token, via a platform operator device 110, in relation to a multi-assets backed security token issued on the token platform 100 of FIG. 1, according to an embodiment of the disclosure.

According to an embodiment of the disclosure, in step 1802, the platform operator device 110 may receive a request to add underlying assets for the multi-assets backed security tokens. According to an embodiment of the disclosure, an underlying asset add request may be transferred to the platform operator by one of various methods, and such request may be entered into the platform operator device 110 by intervention of the platform operator receiving the information. According to another embodiment of the disclosure, the above-described underlying assets add request may be transferred directly via the communication network 120 from the multi-assets backed security token issuer terminal 140 seeking underlying assets addition.

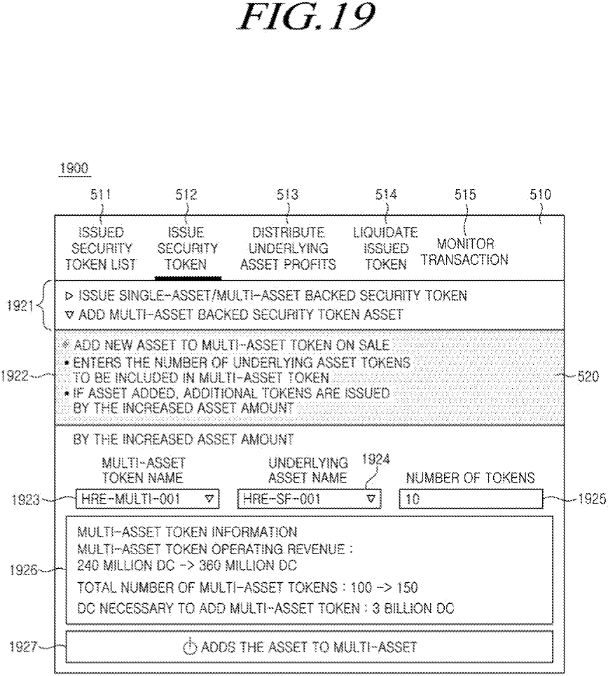

In this regard, FIG. 19 illustrates an interface screen 1900 presented on the display of the platform operator device 110 of FIG. 1, among the user interfaces for the platform operator, according to an embodiment of the disclosure, to proceed with the addition of an underlying asset for a multi-assets backed security token on the token platform 100. According to an embodiment of the disclosure, the user interface that may be presented for the platform operator on the display of the platform operator device 110, as shown in FIG. 19, may basically include a menu bar 510 at the top and a detailed content presentation portion 520 at the bottom, as described above in connection with FIG. 5. As shown, on screen 1900, it may be identified that the “issue security token” item 512 is currently selected among the menu items included in menu bar 510.

Referring to FIG. 19, in the detailed content presentation portion 520 of the screen 1900, a selection portion 1921 is presented that allows the user to select whether to issue a new single-asset backed security token or multi-assets backed security token, or to add an underlying asset to an already issued multi-assets backed security token. As shown in the figure, it is selected to add an underlying asset and a statement 1922 is presented to indicate that the screen is for adding an underlying asset. The screen 1900 also shows a field 1923 (HRE-MULTI-001) for the name of an already issued multi-assets backed security token, a field 1924 (HRE-SF-001) for the name of the underlying asset to be added, and a field 1925 (10) for the number of tokens to be added, by intervention of the platform operator. At the bottom of the portion 520, the changes that occur in the multi-assets backed security token when an underlying asset is added, such as changing operating revenue information and total token quantity information, and the amount of money required to add such underlying asset are automatically calculated and presented (1926). At the bottom of the portion 520, a request input portion 1927 is shown. When the request input portion 1927 is clicked, after the above-described information is entered, a request to add an underlying asset regarding the multi-assets backed security token on the blockchain network 160 is transferred.

Turning back to FIG. 18, according to an embodiment of the disclosure, in step 1804, the platform operator device 110 may invoke and execute smart contract code (e.g., vault contract code) for adding an underlying asset of the multi-assets backed security token on the blockchain network 160. According to an embodiment of the disclosure, the platform operator may invoke and execute vault contract code on the blockchain network 160 in response to clicking on the request input portion 1927 of the screen 1900, e.g., after entering information for adding an underlying asset via the interface screen 1900 of FIG. 19.

In step 1806, according to execution of the vault contract code (including resultant execution of the issuance contract code), a new asset may be bound as the underlying asset of the corresponding multi-assets backed security token. The procedure then proceeds to step 1808 where, according to the bound underlying assets, information about the previously issued multi-assets backed security token may be changed and such change may be recorded on the blockchain distributed ledger.

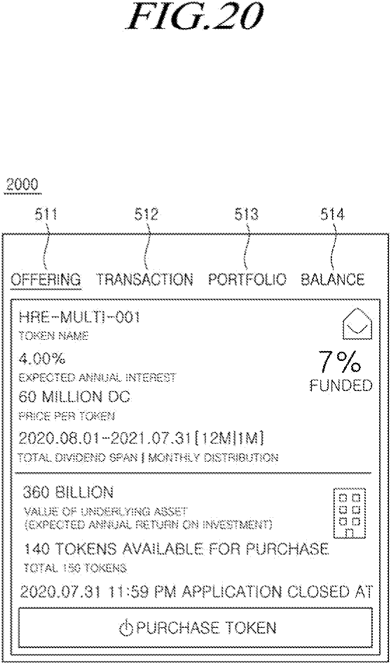

FIG. 20 illustrates an exemplary screen 2000 showing the result of retrieving the changed information of the multi-assets backed security token HRE-MULTI-001 on the display of the investor terminal 150 after 10 HRE-SF-001 tokens are added as the underlying asset for the multi-assets backed security token HRE-MULTI-001 through the process shown in FIGS. 18 and 19. This example assumes that HRE-MULTI-001 is issued by binding 20 HRE-SEOUL-001s and 10 HRE-SINGAPORE-001s as underlying assets, HRE-SINGAPORE-001 is liquidated according to the procedures in FIGS. 15 and 16, and then 10 more HRE-SF-001s are bound as underlying assets for HRE-MULTI-001 according to the procedures in FIGS. 18 and 19. FIG. 20 shows the screen presentation state in such a case. For example, as shown in on the screen 2000, HRE-MULTI-001 has an underlying asset having an expected annual return value of 360 million, which is the sum of 240 million which is the underlying asset value according to 20 HRE-SEOUL-001s and 120 million which is the underlying asset value according to 10 HRE-SF-001s. It may also be identified that as the value of the underlying asset increases, the number of tokens that may be issued increases from 100 to 150 (if the token price per unit is fixed at 60 million ).

As will be appreciated by those skilled in the art, the disclosure is not limited to the examples described herein, but may be modified, reconfigured, and substituted in various ways without departing from the scope of the disclosure. It should be recognized that the various techniques described herein may be implemented by hardware or software, or a combination of hardware and software.

1. A platform operator device supporting issuance of multi-assets backed security tokens on a blockchain network, comprising:
a memory;
a processor;
a display unit; and
a communication unit,
wherein the processor is configured to communicate, via the communication unit and a communication network, with one or more token issuer terminals, one or more investor terminals, and one or more custody institution servers managing a respective digital currency wallet associated with each of the one or more token issuer terminals, each of the one or more investor terminals, or the platform operator device,
wherein the blockchain network includes a plurality of computing devices performing peer-to-peer communication with each other, each of the computing devices including at least a portion of a blockchain distributed ledger that records a plurality of smart contract codes that respectively enable a transaction to occur on the blockchain network, and information regarding each transaction established by execution of each of the smart contract codes, the plurality of smart contract codes including, at least, an issuance contract code and a vault contract code,
wherein the processor, when receiving a first single-asset backed security token issuance request based on a first single-asset from a first token issuer terminal, enables the issuance contract code to be executed on the blockchain network to support issuance of a plurality of first single-asset backed security tokens,
wherein the processor, when receiving a second single-asset backed security token issuance request based on a second single-asset from a second token issuer terminal, enables the issuance contract code to be executed on the blockchain network to support issuance of a plurality of second single-asset backed security tokens, and
wherein the processor, when receiving a multi-assets backed security token issuance request from a third token issuer terminal, enables the vault contract code to be executed on the blockchain network to bind a first number of the first single-asset backed security tokens and a second number of the second single-asset backed security tokens, according to the issuance request, and to support issuance of a plurality of multi-assets backed security tokens using the binding as an underlying asset.

2. The platform operator device of claim 1, wherein the first single-asset backed security token issuance request includes at least one information regarding the first single-asset backed security tokens, among information about the first single-asset, a token name, a total amount of tokens to be issued, a price per token, an operating revenue related to the first single-asset, an expected annual interest related to the first single-asset, a dividend payment period, a time span for which dividends are to be paid, and a token sales closing date,
wherein the second single-asset backed security token issuance request includes at least one information related to the second single-asset backed security tokens, among information about the second single-asset, a token name, a total amount of tokens to be issued, a price per token, an operating revenue related to the second single-asset, an expected annual interest related to the second single-asset, a dividend payment period, a time span for which dividends are to be paid, and a token sales closing date, and
wherein the multi-assets backed security token issuance request includes at least one information related to the multi-assets backed security tokens, among respective numbers of the first single-asset backed security tokens and the second single-asset backed security tokens to be bound by the execution of the vault contract code, a token name of the multi-assets backed security token, a total amount of tokens to be issued, a price per token, a dividend payment period, a time span for which dividends are to be paid, and a token sales closing date.

3. The platform operator device of claim 1, wherein the processor is operable to present, on the display unit, a graphical user interface for issuing an asset backed security token, and wherein the first single-asset backed security token issuance request, the second single-asset backed security token issuance request, or the multi-assets backed security token issuance request are receivable through the graphical user interface.

4. The platform operator device of claim 1, wherein the processor is operable to present, on the display unit, a list including at least one information for the first single-asset backed security token, the second single-asset backed security token, and the multi-assets backed security token, among a token name, an operating revenue, an expected annual interest, a price per token, a total amount of tokens issued, a number of tokens sold, and a time span for which dividends are to be paid.

5. The platform operator device of claim 2, wherein binding of the first number of first single-asset backed security tokens and the second number of second single-asset backed security tokens by the execution of the vault contract code includes, through an execution of the issuance contract code on the blockchain network, transferring the first number of the first single-asset backed security tokens and the second number of second single-asset backed security tokens, respectively, to a token wallet associated with the vault contract code, and transferring sales proceeds corresponding to the transfer of each of the tokens from a digital currency wallet associated with the third token issuer terminal to digital currency wallets associated with the first token issuer terminal and the second token issuer terminal, respectively.

6. The platform operator device of claim 5, wherein binding of the first number of first single-asset backed security tokens and the second number of second single-asset backed security tokens by the execution of the vault contract code further includes, transferring a fee corresponding to the transfer of each of the tokens from the digital currency wallet associated with the third token issuer terminal to a digital currency wallet associated with the platform operator device.

7. The platform operator device of claim 5, wherein transferring of the sales proceeds corresponding to the transfer of each of the tokens includes transferring an amount of digital currency calculated based on the price per token and the first number of the first single-asset backed security tokens to be bound from the digital currency wallet associated with the third token issuer terminal to the digital currency wallet associated with the first token issuer terminal and transferring an amount of digital currency calculated based on the price per token and the second number of the second single-asset backed security tokens to be bound from the digital currency wallet associated with the third token issuer terminal to the digital currency wallet associated with the second token issuer terminal.

8. The platform operator device of claim 1, wherein the processor, when receiving an add request to add a fourth number of fourth single-asset backed security tokens to the underlying asset for the multi-assets backed security token from the third token issuer terminal, enables the vault contract code to be executed on the blockchain network to further bind the fourth number of fourth single-asset backed security tokens to the binding of the first number of first single-asset backed security tokens and the second number of second single-asset backed security tokens according to information in the add request.

9. The platform operator device of claim 8, wherein further binding of the fourth number of fourth single-asset backed security tokens to the binding of the first number of first single-asset backed security tokens and the second number of second single-asset backed security tokens leads to a change in at least one of the total amount of tokens to be issued or the price per token of the multi-assets backed security token.

10. The platform operator device of claim 1, wherein the processor, when receiving, via the communication network, a purchase request for the first single-asset backed security token from an investor terminal, enables the issuance contract code to be executed on the blockchain network to support transfer of a number of the first single-asset backed security tokens based on the purchase request to a token wallet associated with the investor terminal and to support transfer of corresponding sales proceeds and fees from an digital currency wallet associated with the investor terminal to each of a digital currency wallet associated with the first token issuer terminal and an digital currency wallet associated with the platform operator device.

11. The platform operator device of claim 1, wherein the processor, when receiving, via the communication network, a purchase request for the multi-assets backed security token from an investor terminal, enables the vault contract code to be executed on the blockchain network to support transfer of a number of the multi-assets backed security tokens based on the purchase request to a token wallet associated with the investor terminal and to support transfer of corresponding sales proceeds and fees from an digital currency wallet associated with the investor terminal to each of a digital currency wallet associated with the third token issuer terminal and a digital currency wallet associated with the platform operator device.

12. The platform operator device of claim 1, wherein each of the first single-asset backed security token, the second single-asset backed security token, and the multi-assets backed security token is a real estate revenue security type token.

13. The platform operator device of claim 2, wherein the plurality of smart contract codes further include a distributor contract code, wherein the processor, when receiving a dividend distribute request for the first single-asset backed security token, enables the distributor contract code to be executed on the blockchain network to support execution of dividend distribution to each investor terminal associated with the first single-asset backed security token, and wherein the distribute request includes a total profit for the first single-asset backed security token.

14. The platform operator device of claim 13, wherein the processor is operable to present, on the display unit, a graphical user interface for a dividend request for an asset backed security token, and wherein the dividend distribute request for the first single-asset backed security token is receivable through the graphical user interface.

15. The platform operator device of claim 13, wherein the execution of the dividend distribution to each investor terminal includes, for each investor terminal holding at least one of the first single-asset backed security tokens in an associated token wallet on the blockchain network, determining a dividend based on a ratio of a number of the first single-asset backed security tokens held in the token wallet of the investor terminal to a total token amount of the first single-asset backed security tokens issued and transferring the determined dividend from the digital currency wallet associated with the first token issuer terminal to the digital currency wallet associated with the investor terminal.

16. The platform operator device of claim 15, wherein the execution of the dividend distribution to each investor terminal includes, for each investor terminal holding at least one of the multi-assets backed security tokens in an associated token wallet on the blockchain network, determining a dividend based on a ratio of the first number of the first single-asset backed security tokens bound as the underlying asset of the multi-assets backed security token to a total amount of the first single-asset backed security tokens issued and a ratio of a number of multi-assets backed security tokens held in the token wallet of each investor terminal to a total amount of the multi-assets backed security tokens issued, and transferring the determined dividend from the digital currency wallet associated with the first token issuer terminal to the digital currency wallet associated with the investor terminal.

17. The platform operator device of claim 2, wherein the plurality of smart contract codes further include a single-asset backed security token liquidator contract code, and wherein the platform operator device, when receiving a liquidate request for the first single-asset backed security token, enables the single-asset backed security token liquidator contract code to be executed on the blockchain network to support execution of liquidation for the first single-asset backed security token.

18. The platform operator device of claim 17, wherein the execution of the liquidation for the first single-asset backed security token, includes calculating a total liquidation amount for the liquidation, distributing the total liquidation amount to each relevant investor, and burning all of the first single-asset backed security tokens.

19. The platform operator device of claim 17, wherein the execution of the liquidation for the first single-asset backed security token, includes determining a liquidation amount to be distributed to each investor terminal depending on a number of the first single-asset backed security tokens held in the token wallet associated with each investor terminal, transferring each determined liquidation amount from the digital currency wallet associated with the first token issuer terminal to the digital currency wallet of each investor terminal, determining a liquidation amount for the multi-assets backed security tokens depending on the number of first single-asset backed security tokens bound as the underlying asset for the multi-assets backed security token, transferring a predetermined proportion of the determined liquidation amount for the multi-assets backed security tokens from the digital currency wallet associated with the first token issuer terminal to the digital currency wallet associated with each investor terminal depending on the number of the multi-assets backed security tokens held in the token wallet associated with each investor terminal, and transferring a remaining amount after transferring to the digital currency wallet associated with each investor terminal, of the total liquidation amount to the digital currency wallet associated with the third token issuer terminal.

20. The platform operator device of claim 17, wherein the processor is operable to present, on the display unit, a graphical user interface for liquidating the single-asset backed security token, and wherein the liquidate request for the first single-asset backed security token is receivable through the graphical user interface.
